(19) United States
(12) Patent Application Publication
(10) Pub. No.: US 2014/0214206 A1
(43) Pub. Date: Jul. 31, 2014

(54) DEVICE FOR PROVIDING TACTILE FEEDBACK FOR ROBOTIC APPARATUS USING ACTUATION

(71) Applicant: Cambridge Surgical Instruments, Inc., Nashua, NH (US)

(72) Inventors: Kenneth D. Steinberg, Nashua, NH (US); Michael K. St. Amant, Litchfield, NH (US); Jason W. Clark, Milford, NH (US)

(73) Assignee: Cambridge Surgical Instruments, Inc., Nashua, NH (US)

(21) Appl. No.: 14/219,025

(22) Filed: Mar. 19, 2014

Related U.S. Application Data
(63) Continuation-in-part of application No. PCT/US2012/062122, filed on Oct. 26, 2012.
(60) Provisional application No. 61/551,606, filed on Oct. 26, 2011.
(60) Provisional application No. 61/620,659, filed on Apr. 5, 2012.
(60) Provisional application No. 61/711,311, filed on Oct. 9, 2012.
(60) Provisional application No. 61/711,318, filed on Oct. 9, 2012.
(60) Provisional application No. 61/803,214, filed on Mar. 19, 2013.

(51) Int. Cl. B25J 13/08; G06F 3/01

(52) U.S. Cl. CPC B25J 13/084; G06F 3/016
USPC 700/258

(57) ABSTRACT

A haptic feedback system includes a transducer that presses an actuator against an operator's skin with a force corresponding to a sensed parameter. Embodiments provide a simulated sense of touch corresponding to actual interactions between a robotic system and an environment. In other embodiments, the sensed parameter is heat, magnetic field, radioactivity, or electromagnetic field strength. A sensing system generates a signal that is proportional to the sensed parameter, and a controller proportionately manipulates a mechanical linkage or a fluid pressure supplied to the transducer. The transducer can be attached by a band, wrap, or other mechanism anywhere on the operator's body, such as a wrist, ankle, or frontal or occipital bone. An actuator movement range can be adjustable without opening the device. In embodiments, the pressure transducer includes a pair of elements that press an ear lobe or other skin of the operator there between.

### RELATED APPLICATIONS

This application claims the benefit of PCT application PCT/US12/62122, filed Oct. 26, 2012, which claims the benefit of U.S. Provisional Application Nos. 61/551,606, filed Oct. 26, 2011, No. 61/620,659, filed Apr. 5, 2012, No. 61/711,311, filed Oct. 9, 2012, and No. 61/711,318, filed Oct. 9, 2012. This application further claims the benefit of U.S. Provisional Application 61/803,214, filed Mar. 19, 2013. Each of these applications is herein incorporated by reference in their entirety for all purposes.

### FIELD OF THE INVENTION

The invention relates to remotely controlled systems, and more particularly to remotely controlled systems that include tactile feedback.

### BACKGROUND OF THE INVENTION

For more than two decades the field of robotics and remote controlled machine systems (production equipment, gaming systems and handicapped equipment etc.) has been advancing at a steady rate. The capabilities, intelligence, and level of control are on a constant improvement cycle that is yielding amazing results.

Similarly cybernetic systems are advancing in almost all aspects, including dexterity, strength, cognitive thinking, and human factors. While many decades will pass before robotics systems will fully replace human functions, there is no doubt that effort and innovation in this field will continue.

One of the problems surrounding man-machine interfaces is still the subject of considerable research and little success—haptics. Haptics is the ability to provide tactile feedback similar to what the human physiology can provide. Within days of being born, humans start to develop an enhanced level of sensory feedback, one of which being touch. The sense of touch plays out in many ways, but none more dramatic than when combined with visual feedback, leading to the development of hand-eye coordination.

Cybernetic systems currently provide very rudimentary tactile feedback, leading to a very disjointed sense of control. In many cases, the rudimentary forms of feedback currently provided are more of a detriment to working with man-machine interfaces than an enhancement. Still, robotic systems continue to work their way into many aspects of life, despite the fact that the existing gap in eye-hand, haptic coordination remains.

Much of the present day robotic system interfaces are relegated to nothing more than enhanced video gaming style controls. Surgeons, for example, using cybernetic interfaces to control surgical robots are confined to joystick controls and video representations of the patients they are working on. Some of the most advanced cybernetic interfaces provide control interfaces that are only marginally better then 3D television. The same holds true for military, production, and handicapped interfaces. Varying levels of vibration and the use of cumbersome resistive interfaces remain at the forefront, with little appreciable change in approach.

True interfacing with the human nervous system, which would allow for direct stimulation of the senses, is yet to be realized, as there is still considerable research to be conducted on the nervous system and how the various regions of the brain react to stimuli. Researchers are in the very early stages of understanding the human brain, let alone all of the individual permutations due to genetic diversity. The realization of actual mind-controlled systems or symbiotic nervous system interfaces is still many years in the future.

Further complicating the man-machine interface issue is that of infection. Any device that penetrates the dermis provides an opportunity for disease and infection to take hold. Methicillin-resistant Staphylococcus Aureus (MRSA) is a prime example of how a simple, small incision in the skin can create a life threatening situation. Regardless of antibiotics and instrument coatings (ex. colloidal silver), the risk and chance of infection are still high, greatly reducing the ability to create true man-machine interfaces.

Given the current state of the industry and the years of research still waiting to be funded and conducted, new methods of providing lighter, more representative haptic interfaces are needed to keep pace with the integration of robotic systems into society. Vibration-based implementations are limited by the proclivity of the epidermis to thicken the skin near the area of vibrational contact (callusing). Callusing in turn reduces the sense of touch, making the vibration system inherently less effective over time. The same holds true for proximity, as research has shown that close proximity of vibration sources confuses the sense of touch due to wave propagation in the epidermis. Nerve endings near multiple vibration sources tend to confuse feedback, leading to a deadening effect.

What is therefore needed is a haptic feedback interface that can provide operators with sensory feedback yet does not impact the operator's ability to interface with robotic control systems.

### SUMMARY OF THE INVENTION

The present invention, most fundamentally stated, is a system designed to proportionally translate a physical characteristic of an interaction between an automated component, which might or might not be characterized as “robotic,” and an environmental characteristic or an object with which the component makes contact, to the nerve endings or sensory system of the component operator or controller, without impeding the motion or encumbering the extremities of either the component or the operator or controller. In embodiments, the “physical characteristic” is the pressure induced when the automated component makes physical contact with an object, so that the embodiment generates an awareness of the degree of pressure being applied by the component to the object. In other embodiments, the physical characteristic is a temperature, a magnetic field, a degree of radioactivity, or some other physical characteristic.

Note that the term “induced pressure,” is used herein to refer to any such physical parameter, including translation and awareness of the surface pattern or contour or surface tension or compression of the object, separately or in combination, to directly or indirectly translate awareness and degree of parameters radiated by the object, such as light or heat or electromagnetic emissions. Furthermore, while sensing pressure on the component by applying pressure to the equivalent nerve endings of the operator represents the most direct form of translation, the area of stimulation and the form of stimulation applied to the operator for creating the desired awareness of the parameter or parameters being sensed varies according to the embodiment.

In embodiments of the invention, a device is connected to the sensory system output of the robotic system which operates a drive element by increasing or decreasing the pressure of a gas or other fluid in a haptic interface system or mechanically moving a drive element such as a guide wire, thereby causing movement of an actuator, acting like a piston, solenoid, or lever, which is located against the skin of the operator. In embodiments, the drive element in the haptic interface system controls an inflatable diaphragm, baffle, or piston which drives the actuator. The actuator is attached to the operator in a manner that does not impair hand, finger, or body movements required for control of the robotic system. In some embodiments, the device is mounted in fabric or held by a band that is applied to or wrapped around the body or an extremity of the operator. In other embodiments the device is clipped onto an extremity of the operator so as to apply pressure to the nerve endings in the skin.

In embodiments, the drive element induces changes in the actuator's position by translating signals from the robotic interface into changes in pressure, in linear actuation, or in rotary position. As a result, the actuator placed against the wearer's skin is moved in a manner which directly correlates to the environmental change experienced by the robotic system, all without impacting the dexterity of the operator

In some embodiments, the actuator is pressure-controlled, and is connected to a small pressure hose that is, in turn, connected to pressure modulation hardware which varies the pressure in a feed-line, causing a diaphragm or baffle in the actuator to expand and contract in a manner similar to a balloon. Each diaphragm is enclosed in a small housing which provides an interface for the pressure hose. In various embodiments, the housing also provides a means by which the actuator can be attached to a band or elastic material which can be wrapped around the operator to hold the invention against the skin.

In other embodiments, the pressure line is attached to a piston which drives a wedge or rotational mechanisms. The piston motion is thereby converted into pressure sensations by the use of mechanical advantage, such as by a lever, arm, or gear. In this manner the invention may be attached to the operator as a cuff or clip, so as to apply pressure to one or more nerve endings in proportion to the environmental changes being experienced by the robotic system.

In still other embodiments, fluid pressurization is replaced by mechanical linkage which drives the motion of a piston using levers, arms, or gears. In this manner, the invention is placed against the skin of the operator and applies pressure to one or more nerve endings in proportion to the environmental changes being experienced by the robotic system

In various embodiments, transducers and sensors affixed to the robotic device create electrical signals that are transmitted to electrical or electronic components which control the drive element for each actuator, increasing and decreasing line pressure or motion in proportion to the robotic sensor readings. In this manner, when a robotic system transmits a change in its environment, such as pressure at a point of impact, as for example in a gripping claw, the operator feels an increase in pressure against the skin located under the actuator. A similar decrease in a pressure or another environmental condition results in a relaxation of the actuator and reduced stimulation of the associated nerve endings. In other embodiments, a transducer affixed to the robotic device senses a temperature, magnetic field, level of radioactivity, or other physical or environmental characteristic and creates the electrical signals that ultimately result in proportional movements of the actuator against the operator's skin.

In various embodiments of the invention, a single actuator is used to provide pressure against the skin, correlating to a single sensor. In other embodiments, a pair of actuators is employed to simulate a squeezing motion instead of a press or pull motion. In some applications a grip, simulated as a squeeze, can be critical, such as the gripping of a vein or suture.

In yet other embodiments of the invention, one or more actuator units are mounted to a wrap or other attachment mechanism in a manner that allows the device's subcomponents to be easily replaced.

In some embodiments that use pressure transduction, fittings in the pressure hoses are included which allow the individual housings to be disconnected from the line and replaced by new elements, should the need arise. In some embodiments these fittings are as complex as pressure couplers, while in other embodiments they are as simple as barbed hose attachments that provide an air-tight seal when reattached. This allows for the complete replacement of the device or repair/replacement of subcomponents of the device, and facilitates field replacement and upgrading of devices at the point of use.

Additional, pressure transduction embodiments include the use of any gas or liquid in substitution for air. In some applications, environmental factors such as ambient heat and humidity make the use of other gases, like nitrogen, feasible alternatives to air in order to retain or fine-tune performance. It is even feasible to employ liquids in certain extreme cases, since they can provide linear compression characteristics in various extreme conditions. It should be noted that consideration must be given to potential environmental interaction between certain reactive gases and materials near the point of use. There may be instances where pressure lines may be opened or bled in order to calibrate the system. The venting of gases and fluids could be harmful in certain situations.

In some embodiments, individual pressure lines are regulated from a central pressure vessel by using computer or electronically controlled pressure regulators to control specific actuators. The pressure variation per actuator can be controlled via individual compressions/pressure systems or from a single pressure system with individual pressure regulators controlling specific feed line pressures.

In other embodiments, line pressurization can be achieved by attaching pressurized containers to the operator as an attachment or wearable component. This can provide a pressurized feed for one or more pressure actuator devices attached to the operator.

In further pressure transduction embodiments, the pressurization system can be configured as a closed system which is pressurized for a limited use cycle without need of a directly attached feed. In this manner, the invention can be used until the line pressure decreases. This loss of pressure can be overcome by re-pressurizing the system, or by changes in the volume of the feed lines that result in recovery of pressure.

Further pressure transduction embodiments of the invention provide for the ability to recalibrate the pressure in the system. In gas pressurized implementations, moisture in the gas may condense in the lines, causing a need to clean or drain the liquids. Additionally, the replacement of actuator units can require opening of the pressure lines and therefore can require system recalibration when the new units are installed and the pressure system is re-sealed. The user may also wish to fine-tune the responsiveness of the actuators to the robotic system by changing the overall system pressure using a venting or bleeding process. The varying elasticity of the epidermis and underlying muscle in different body locations or on different operators may also require calibration and adjustment.

In further embodiments of the invention, diaphragm housings are fitted to wraps and bands that are made from varying material in varying sizes for various locations on the operator's body. In some embodiments, at least one of the actuators is attached at the rear of the operator's skull, resting on the occipital cranial bone near the lambda region. This location is sensitive to pressure changes in the epidermis. In various embodiments, the invention is mounted in an elastic strap or plastic band which can be wrapped around the operator's skull to hold the actuator unit in place.

In other embodiments of the invention, the drive element used to move the actuator employs a mechanical linkage which is connected to a servo, motor, or other device capable of increasing and decreasing the length of the linkage between the device worn on the operator and the controlling system. Additionally, in some of these embodiments the linkage moves in one or more degrees of motion or rotation, causing the actuator against the operator's skin to extend or retract.

In yet other embodiments of the invention, the actuator used to apply pressure to the operator's nerves has a motion achieved by the movement of one or more inclined wedges that move against or towards each other, perpendicular to the motion of the actuator and moving against a mating inclined plane at the base of the actuator to cause a rise or fall in motion.

Further embodiments of the invention make use of either or both skin tension against the actuator and/or a spring to return the actuator to a retracted position, so as to lessen the pressure felt against the skin of the operator.

Some embodiments of the present invention include a clip which can be attached to the operator's ear in a manner which allows the invention to apply pressure to the cartilage of the ear without impacting auditory function. Embodiments can clip to the ear anywhere between the helix and lobule. Other embodiments apply pressure to the fossa or concha regions of the ear.

These attachment mechanisms and locations, amongst others, are ideal, as they leave the operator's hands unencumbered, so that there is no loss of manual dexterity or eye-hand control. Specialists such as surgeons and bomb diffusion technicians require very precise manual control in order to function at a high level. This degree of dexterity would be reduced if vibration or pressure systems were to adversely affect the operator's range of motion or working conditions.

Additional embodiments of the invention include various means of tightly placing the actuators against the operator's skin such that pressure changes are easily detected. These attachment mechanisms include, but are not limited to, wrist bands, head bands, ear clips, rings, nose clips, neck braces, arm bands, leg braces, and such like.

In further embodiments of the invention, the wraps into which the diaphragm housings are fitted are made from varying material in varying sizes for various locations on the operator's body. In one example, a transducer is included in a neoprene neck-wrap that can be fitted to the operator and affixed using a Velcro fastener or closure. This places the transducer on the neck, allowing it to apply pressure to the nerve endings there without impeding the control motions of the operator. This is especially important when it comes to leaving the operator's hands unencumbered, so that there is no loss of manual dexterity or eye-hand control. Specialists such as surgeons and bomb diffusion technicians require very precise manual control in order to function at a high level. This degree of dexterity would be reduced if vibration or pressure systems were to adversely affect their range of motion or working conditions.

Still other embodiments of the invention rely on mechanical rather than pneumatic means for transferring forces to the feedback actuators or generating forces locally at the actuators, such as guide wires, motors, electromotive materials (such as nitinol) and electromagnetic devices.

In embodiments of the invention, a haptic device is actuated by one or more sensors associated with the automated component. When actuated, the haptic device changes the position of a linear actuator that is located against the skin of the operator. In some of these embodiments the haptic device changes the length of a control wire, which in turn causes the actuator, acting in various embodiments like a piston, or solenoid, to touch or press against the operator's skin. In various embodiments, the control wire acts to relieve an otherwise constant pressure that is applied by a spring mechanism to a plunger that is placed against the skin. The control wire pulls on the plunger and retracts it away from the skin, while the spring acts as a constant pressure and return mechanism. This interaction between the spring (forcing expansion) and the control wire (forcing retraction) allows for the use of a flexible control wire, because the control wire is only used to retract, not to apply pressure. The haptic device can be mounted in fabric or held by a band that is applied to or wrapped around the body or an extremity of the operator in a manner that does not impair the hand, finger, or body movements that are required for control of the robotic system.

In some of these embodiments, the haptic device includes a control mechanism (motors, servos, etc.) which varies the length of the control wire based upon an electronic interface that translates information such as pressure or temperature that is sensed at the automated component into appropriate electrical signals that drive the control mechanism. Certain of these embodiments include a plurality of plungers, each of which is enclosed in a small housing that provides an egress for the control wire and acts as a container for the spring that pressurizes the plunger. In some of these embodiments, the housing also provides a means by which the actuator can be attached to a band or to elastic material that can be wrapped around some portion of the operator to hold the invention against the skin.

In various embodiments, pressure transducers or sensors affixed to the automated component emit electrical signals that are transmitted to the electrical or electronic components that control the mechanical drivers for each of the actuators, thereby increasing and decreasing the control wire lengths in proportion to the sensor readings. In this manner, when a sensor transmits a signal indicating an increase in pressure at a point of impact, as for example in a gripping claw, the operator feels a corresponding increase in pressure against the skin located under the actuator. A similar decrease in pressure at the automated component results in a relaxation of the actuator and a reduction of pressure against the skin located under the actuator. In other embodiments, a transducer affixed to the robotic device senses a temperature, magnetic field, level of radioactivity, or other physical or environmental characteristic, and creates the electrical signals that ultimately result in proportional control wire length variations and proportional changes in the pressure of an actuator against the operator's skin.

In some embodiments of the present invention, a single actuator is used to provide pressure against the skin, correlating to a single pressure transducer. In other embodiments, a pair of actuators is employed to simulate a squeezing motion instead of a pressing or pulling motion. In some applications a grip, simulated as a squeeze, can be critical, such when gripping a vein or suture.

In still other embodiments, several actuators are placed against the operator's skin in order to provide multiple points of feedback. The contact points can be interconnected as a chained unit or located in various diverse positions on the operator's body.

In further embodiments, the pressurization of the plunger can be achieved using any combination of springs, fluids, gases, and opposing control wires which push and pull the plunger in opposite directions within the actuator housing.

In some embodiments individual control lines are regulated from a central control mechanism by using a computer or other electronically controlled mechanisms to control specific actuators. The ability to act upon various control wires can be managed by the use of variable clutches or gears.

Further embodiments of the invention provide for the ability to recalibrate the control wire, plunger position, and throw by providing various adjustment interfaces within the system. The control wire length can be adjusted by the use of an adjustable clamping or ratcheting apparatus. Adjustments to the plunger position and throw can be accomplished by adding a threaded interface between the plunger chamber and a cap. Loosening or tightening the cap will thereby change the length of the pressure spring, which will in turn change the protrusion and throw of the plunger. Further adjustments to the characteristics of the actuator can also be effected by electronically controlling the motion of the control mechanism which maintains the movement of the control wire. Electronic control can affect responsiveness, zero settings, plunger throw, and bi-directional speed, as well as many other variables.

In further embodiments of the invention, the cable system can be replaced with a fixed rod which is attached to the top of the plunger and is attached to one side of a lever. The control cable is then attached to the opposite side of the lever, allowing the control cable, when retracted, to pull on the lever and drive the rod and plunger down, causing additional pressure to be applied to the operator. When the cable is relaxed or extended, the rod and plunger are retracted by the elasticity of the operator's skin and the optional placement of a spring between the bottom of the plunger and the bottom of the plunger chamber/cylinder closest to the operator's skin. This spring provides additional power for pushing the plunger back up into the chamber, reducing the pressure applied to the operator.

Additional embodiments include the ability to add sensors to the actuator such that feedback is supplied to the control electronics allowing it to automatically recalibrate the actuator on an as-need basis. The varying elasticity of the epidermis and underlying muscle in different body locations or on different operators may also require calibration and adjustment.

In further embodiments of the invention, the wraps and/or bands to which the invention is fitted are made from varying materials in varying sizes for application to various locations on the operator's body. In some embodiments, at least one of the actuators is located at the rear of the operators skull, resting on the occipital cranial bone near the lambda region. This location is sensitive to pressure changes in the epidermis. In various embodiments the invention is mounted in an elastic strap or plastic band which can be wrapped around the skull to hold the actuator unit in place. This location, amongst others, is also ideal, because it leaves the operator's hands unencumbered, so that there is no loss of manual dexterity or eye-hand control. Specialists such as surgeons and bomb diffusion technicians require very precise manual control in order to function at a high level. This degree of dexterity would be reduced if vibration or pressure systems were to adversely affect the operator's range of motion or working conditions.

Additional embodiments of the invention include various means of tightly placing the actuator or actuators against the operator's skin such that pressure changes are easily detected. These attachment mechanisms include, but are not limited to, wrist bands, neck braces, arm bands, leg braces, and such like.

One general aspect of the present invention is a haptic feedback device that includes a transducer in communication through a drive element with a controller that varies at least one variable feature of the drive element in proportion to at least one sensed parameter, a skin-contacting element cooperative with the transducer, an attachment mechanism that enables attachment of the transducer to an operator, such that the skin-contacting element is located proximal to skin of the operator, and an actuating mechanism that causes the skin-contacting element of the actuator to be pressed against the skin of the operator with a force that is proportional to the variable feature of the drive element, and thereby proportional to the sensed parameter.

Some embodiments further include a recession device that applies a force to the actuator in opposition to a force applied by the drive element.

In certain embodiments, the drive element is a pressurized fluid connecting the controller with the transducer, the fluid being received into a fluid input of the transducer, and the variable feature is a pressure of the pressurized fluid.

In some of these embodiments, the pressurized fluid is one of air, nitrogen gas, water, and hydraulic oil. In other of these embodiments the actuating mechanism includes a flexible diaphragm, and the skin-contacting element is an exposed surface of the flexible diaphragm that is extended proportionally outward by the pressurized fluid until the exposed surface presses against the skin of the operator.

In various of these embodiments, the transducer further includes a housing, a sealed internal volume enclosed within the housing, the sealed volume being filled with the pressurized fluid, the fluid inlet providing fluid communication between the pressure control system and the fluid in the sealed internal volume, an access port that penetrates a wall of the housing but does not penetrate the sealed internal volume, and an actuator contained at least partly within the housing, the skin-contacting element being a portion of the actuator that is slidably extendable through the access port to touch the skin of the operator. And in some of these embodiments, the actuating mechanism includes at least one piston that is mechanically cooperative with the actuator and in fluid communication with the sealed internal volume, so that pressure changes of the pressurized fluid in the sealed internal volume cause proportionate changes of a pressing force applied by the piston to the actuator. Also, in some of these embodiments the piston and the actuator are fixed together as a common element. And in other of these embodiments the actuating mechanism includes a flexible diaphragm that separates the sealed internal volume from an unsealed internal volume of the housing, the actuator being contained at least partly in the unsealed internal volume and being mechanically cooperative with the diaphragm, so that pressure changes of the fluid in the sealed internal volume flex the diaphragm and transfer a pressing force to the actuator.

In certain of these embodiments, the pressure transducer further includes a chamber having a sealed internal volume filled with the pressurized fluid, and a mechanical coupling that is reversibly moved in a translational direction according to the pressure variations of the pressurized fluid filling the sealed internal volume, the mechanical coupling being cooperative with the actuating mechanism. In some of these embodiments at least one dimension of the chamber is reversibly expandable and contractible in response to the changes in pressure of the fluid, and the mechanical coupling is a movable wall of the chamber. In other of these embodiments the chamber is a bellows. And in still other of these embodiments the chamber is a cylinder that drives a piston.

In other embodiments, the drive element is a mechanical linkage connecting the controller with the transducer, and the variable feature is at least one of a linear position and a rotary orientation of the mechanical linkage.

Various embodiments further include a throw adjustment mechanism that adjusts a range of movement of the actuator. In some of these embodiments the throw adjustment mechanism is a ring that is adjusted by rotation thereof. In other of these embodiments the throw adjustment mechanism can be adjusted without opening or disassembling the device.

In various embodiments the actuating mechanism includes a pair of sides joined by a hinge, the pair of sides being separated in a forward section by a forward gap and in a rear section by a rear gap, the forward gap and the rear gap being either directly or inversely proportional to each other as governed by the hinge, the contact linkage being able to grasp skin of the operator within the forward gap and apply a haptic pressure thereto in proportional to a gap-changing force applied by the mechanical coupling to the rear gap.

In some of these embodiments, the actuating mechanism is able to grasp a portion of an ear of the operator within the forward gap. And in some of these embodiments the attachment mechanism includes a hook that suspends the device from the ear of the operator.

In other of these embodiments the drive element is a pressurized fluid supplied to a bellows that expands in length along an expansion axis when a pressure of the pressurized fluid is increased, and contracts along the expansion axis when the pressure of the pressurized fluid is decreased, said bellows being coupled to the rear gap by the mechanical coupling such that pressure variations of the fluid in the bellows cause corresponding forces to be applied to the rear gap.

In still other of these embodiments the drive element is a pressurized fluid supplied to a cylinder that drives a piston, said piston being coupled to the rear gap by the mechanical coupling so that outward and inward movements of the piston cause corresponding forces to be applied to the rear gap.

And in et other of these embodiments the piston drives a wedge into and out of the rear gap.

In various embodiments the attachment mechanism includes a band that can encircle and attach to a portion of the operator's body.

In certain embodiments the attachment mechanism provides for attachment to the operator with the skin-contacting element proximal to skin on the neck of the operator.

In some embodiments the attachment mechanism provides for attachment to the operator with the skin-contacting element proximal to the occipital cranial bone of the operator's skill near the lambda region.

In other embodiments the at least one sensed parameter includes at least one of a mechanical pressure, a physical position, a temperature, a magnetic field, a level of radioactivity, and an intensity of electromagnetic radiation.

Various embodiments further include a sensing system, the control system being able to vary the variable feature of the drive element according to signals received from the sensing system.

In some of these embodiments the sensing system is cooperative with a movable device and generates a signal according to a degree of pressing force between the movable device and another object.

Other of these embodiments further include a plurality of transducers connected to the controller. And in some of these embodiments the sensing system is cooperative with a movable device that can apply a squeezing force to an object, and a pair of transducers are cooperatively controlled by the control system in proportion to a strength of the squeezing force.

In embodiments, the drive element is a flexible actuating wire slidably penetrating the housing and fixed to the actuator, the actuating wire being configured to withdraw the skin-contacting portion of the actuator from the skin of the operator when a pulling force is applied to the actuating wire, the variable feature is a tension of the actuating wire, and the transducer further includes a housing.

Some of these embodiments further include a pulley configured to re-direct the actuating wire, so that the pulling force is applied to the actuating wire along a pulling direction that is not parallel with the longitudinal direction. And in some of these embodiments the pulley is configured to allow the pulling force to be applied to the actuating wire along any of a plurality of pulling directions.

In various of these embodiments, the actuating mechanism is a spring located within the interior of the housing. And in certain of these embodiments the spring includes tapered coils configured to nest within each other when the spring is compressed, thereby avoiding stacking of the coils when the spring is compressed.

Some of these embodiments further include a cap, and a threaded interface located between the actuator and the cap, so that loosening or tightening the cap changes the length of the spring, and thereby changes a protrusion and throw of the skin-contacting element.

In other of these embodiments the attachment mechanism includes a feature of the housing configured for attachment to a band or to elastic material that can be wrapped around a portion of the operator.

In certain of these embodiments the device includes a pair of actuators configured to apply a squeezing force to the skin of the operator.

In various of these embodiments, a length of the actuating wire can be adjusted by operating an adjustable clamping or ratcheting apparatus. And some of these embodiments further include at least one sensor cooperative with the actuator, the at least one sensor enabling automatic calibration of the device.

In embodiments, the transducer further includes a housing having an access port, the drive element is a substantially rigid actuating rod slidably penetrating the housing and having a distal end fixed to the actuator, the actuating rod being configured to vary the extension of the skin-contacting portion of the actuator through the access port when a longitudinal force is applied to the actuating rod, and the variable feature is the longitudinal force applied to the actuating rod.

Some of these embodiments further include a lever having a first side fixed to a proximal end of the actuating rod and a second side attached to a control cable, so that a pulling force applied to the control cable is transferred by the lever to the actuating rod. Certain of these embodiments further include a pressing mechanism configured to apply a force to the actuator tending to oppose the force applied by the control cable and lever. In various of these embodiments the pressing mechanism is a spring. In some of these embodiments the spring includes tapered coils configured to nest within each other when the spring is compressed, thereby avoiding stacking of the coils when the spring is compressed. Other of these embodiments further include a cap, and a threaded interface located between the actuator and the cap, so that loosening or tightening the cap changes the length of the spring, and thereby changes a protrusion and throw of the skin-contacting element.

In various of these embodiments the attachment mechanism includes a feature of the housing configured for attachment to a band or to elastic material that can be wrapped around a portion of the operator.

In certain of these embodiments the device includes a pair of actuators configured to apply a squeezing force to the skin of the operator. In some of these embodiments a length of the actuating rod can be adjusted by operating an adjustable clamping or ratcheting apparatus. And in other of these embodiments at least one sensor cooperative with the actuator, the at least one sensor enabling automatic calibration of the device.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A illustrates the basic concept of physical touch by a human hand and physical feedback via the nervous system to the brain;

FIG. 1B illustrates a prior art haptic analog of FIG. 1A, whereby physical touch by a robotic device is sensed, and displayed as an electronic waveform;

FIGS. 2A through 2C are side views of an embodiment that uses an actuator controlled by a pneumatically driven diaphragm to emulate the sense of touch and pressure via pressing of the actuator against the skin of an operator;

FIGS. 2D through 2F are side views of an embodiment similar to FIGS. 2A through 2C, except that the pneumatically driven diaphragm itself flexes outward and applies pressure to the skin of the operator;

FIGS. 3A and 3B are cut-away views of an embodiment similar to FIGS. 2A-2C;

FIGS. 3C and 3D are cross-sectional views of an embodiment that uses a spring-driven piston in lieu of a diaphragm;

FIGS. 4A and 4B are perspective views of the embodiment of FIGS. 3A and 3B;

FIG. 5A is a rear view of an operator wearing an actuator unit held by a strap against the operator's occipital bone;

FIG. 5B is a side view of an operator's arm with an actuator unit strapped to the operator's wrist;

FIG. 6 is a high level system diagram showing the individual subsystems, their relations to each other, and how the overall system supports end-to-end integration in an embodiment of the present invention

FIG. 7A is a perspective view from above of an embodiment which incorporates a threaded construction and an adjustment ring for adjusting the throw of a plunger;

FIG. 7B is a perspective view from slightly below of the embodiment of FIG. 7A;

FIG. 7C is an exploded view of the embodiment of FIG. 7A

FIG. 8A is a perspective view from below of an embodiment similar to FIG. 7A, but including an externally accessible adjustment ring for adjusting the throw of the plunger;

FIG. 8B is a sectional side view of the embodiment of FIG. 8A;

FIG. 8C is a perspective view of the throw adjustment ring included in the embodiment of FIG. 8A;

FIG. 9 is a perspective view of a haptic device that attaches to the operator's ear, applying pressure to the lobe via a pressure activated clip;

FIG. 10A is a perspective view of the embodiment of FIG. 9 shown in an un-actuated state;

FIG. 10B is a perspective view of the embodiment of FIG. 9 shown in an actuated state;

FIG. 11A is a perspective sectional view of the embodiment of FIG. 9 with the sectional cut taken through the bladder actuator;

FIG. 11B is a perspective view of the bladder actuator of FIG. 11A;

FIGS. 12A and 12B are perspective views from the left and right sides respectively of an embodiment similar to FIG. 9 that uses a piston driven wedge instead of a bladder to actuate the lob clip;

FIG. 13A is a side view of the embodiment of FIG. 12A showing the actuator in an un-actuated state;

FIG. 13B is a front view of the embodiment of FIG. 12A showing the actuator in an un-actuated state;

FIG. 13C is a side view of the embodiment of FIG. 12A showing the actuator in an actuated state;

FIG. 13D is a front view of the embodiment of FIG. 12A showing the actuator in an actuated state;

FIG. 14A is a side view of an embodiment having a scissors configuration instead of a clip configuration, shown in the un-actuated state;

FIG. 14B is a side view of an embodiment having a scissors configuration instead of a clip configuration, shown in the actuated state;

FIG. 15A is a cut-away perspective view of an actuator in an embodiment of the present invention.

FIG. 15B is a perspective view of the embodiment of FIG. 15A;

FIG. 16A is a perspective view similar to FIG. 15B, but showing the direction of attachment of a locking, self-sealing retaining ring as a means of attaching the diaphragm and sealing the pressure system.

FIG. 16B is a perspective view of the actuator of FIG. 16A shown with the retaining ring fully installed;

FIG. 17A is a left-side view of a pressure wrap mounted on the neck of an operator;

FIG. 17B is a right-side view of the pressure wrap of FIG. 17A;

FIG. 18A depicts the outer side of the neck wrap of FIGS. 17A and 17B when not mounted on the operator;

FIG. 18B depicts the inner side of the neck wrap of FIGS. 17A and 17B when not mounted on the operator;

FIG. 19A is a cut-away perspective view of yet another actuator design in an embodiment of the present invention which allows for a snap closure for attaching or mounting the transducer in a body appliance or wrap material;

FIG. 19B is a perspective view of the actuator of FIG. 19A;

FIG. 20A is a perspective view of a mechanically driven actuator embodiment of the present invention, shown with the piston is in the retracted position;

FIG. 20B is a perspective view of the mechanically driven actuator of FIG. 20A shown with the piston in the extended position;

FIG. 20C is a transparent view of the base of the actuator housing of FIG. 20A, showing the static and moveable wedges;

FIG. 20D is an exploded view of the mechanically driven actuator embodiment of FIG. 20A;

FIGS. 21A and 21B are two perspective views of an embodiment of the present invention, one shown from the top and the other from the bottom, respectively;

FIGS. 22A and 22B present two cut-away views of an embodiment of the present invention, where the plunger is fully extended in FIG. 21A and fully retracted in FIG. 21B, the motion of the plunger being a result of a change in spring compression effected by motion of the control wire;

FIG. 23 is a transparent view of an embodiment of the present invention, showing all internal components as they relate to the external casing; and

FIG. 24 presents an overview of the interaction between the system-level components that provides the intended haptic effect.

### DETAILED DESCRIPTION

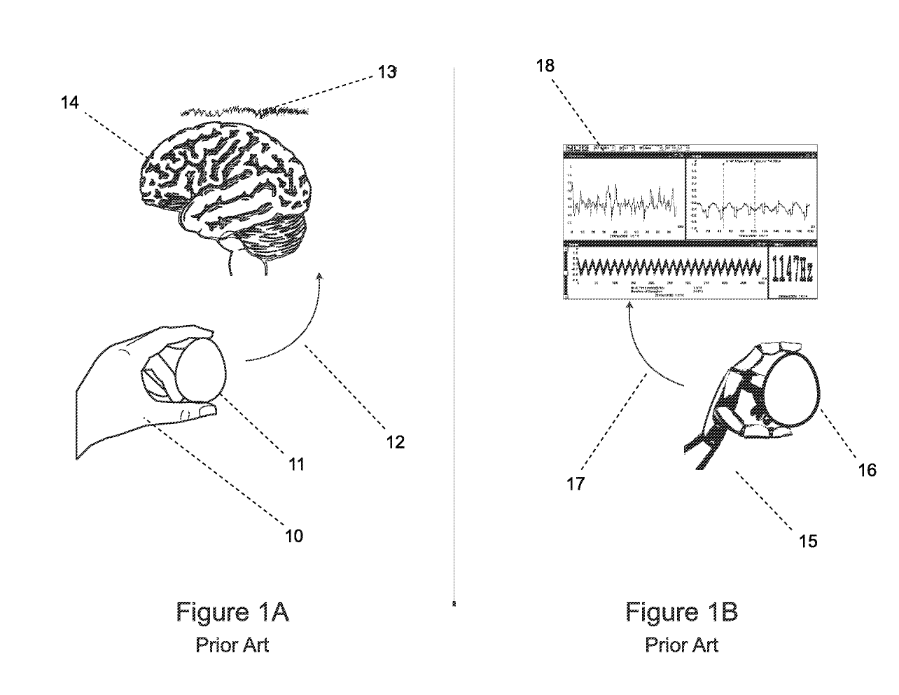

FIG. 1A illustrates the physiological concept of human touch sensation and FIG. 1B illustrates the robotic analogy. As an example, FIG. 1A shows a human hand 10 squeezing on an egg 11. This sensation 12 is transmitted to the brain 14 in the form of signals 13 from the nerve endings in the finger tips and hand muscles. This feedback allows the human brain to control the muscles as they contract, avoiding crushing the egg while still allowing a human to hold it. In addition, if the intent was to crush the egg, the brain would continue to apply pressure, via muscle contraction, until the release of pressure was felt, aka the egg crushing.

With reference to FIG. 1B, in modern robotics a similar scenario is problematic. A robotic hand 15 may try to hold an egg 16 without crushing it. The operator of the robotic hand has only pressure transducer output 17 which is depicted as an electronic signal 18 on a display. There is no direct means of providing an interface with the human brain 14 that allows for the same delicate level of muscle control in the robotic hand 15. As a result the egg 16 might be dropped or crushed. The operator must use other senses, such as sight, to control the robot.

Holding an egg 16 is a very simple example which might be achievable in a lab environment after the operator has had sufficient time to practice. Some uses of robotic equipment do not provide the operator with full use of other senses to compensate for the loss of touch. A surgeon performing an operation via robotic assistance, which still provided with visual input via a camera, may be working with tissue, arteries, or sutures which do not have a level of tolerance to pressure that an egg shell would. Similarly, the operator of a bomb squad robot may require very delicate control and feedback that pure visual input cannot provide. Trigger switches and wires may be pressure intolerant resulting in catastrophic outcomes. Providing some means to include a proportional sense of touch without encumbering the operator's motions is critical.

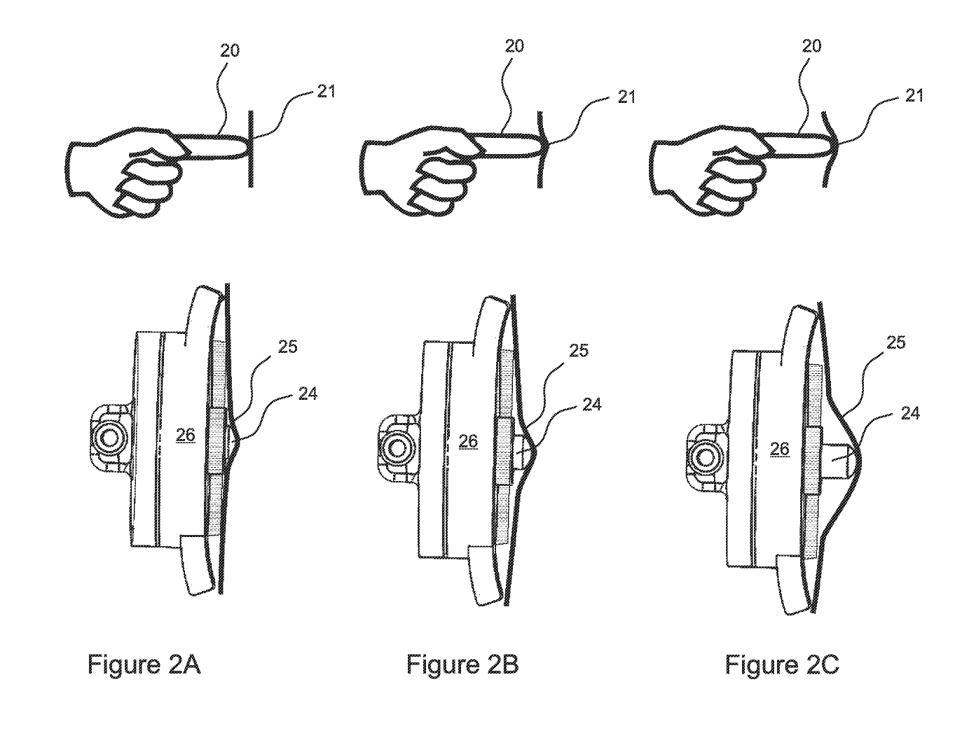

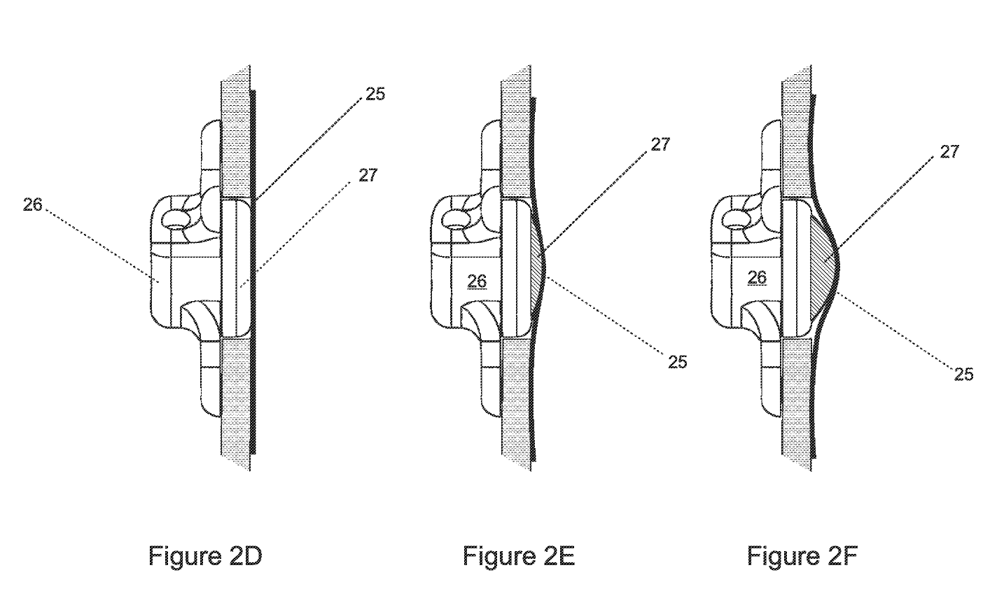

FIGS. 2A through 2C introduce the concept of simulating pressure by using an actuator 24 placed against the skin of the operator 25. Much like the way in which a human hand 20 can create a sensation of pressure on the skin 21 by deforming it. The nerve endings under the skin 21 transmit the pressure to the human brain, causing it to give the operator the sensation of touch. In the case of a machine performing an action on behalf of an operator, the tactile feedback transmitted to the operator as a result of their hand 20 coming into contact with a surface 21 is not felt. The invention reverses the paradigm by taking the pressure felt by the machine (for example a robotic device), through the use of sensor equipment or extrapolation of power usage, and translating the pressure to nerve endings on the operator. While the operator is not directly feeling the pressure applied by the machine, this pressure is transduced to an actuator 24 that presses on the skin 25, effectively mimicking the sense of touch.

The housing 26 can be placed up against the skin 25 by mounting it in a piece of material or a band which can then be affixed or wrapped around a part of the operator's body, (ex. wrist, neck, arm) such that when pressure is increased in the housing 26, an internal diaphragm expands and applies pressure to the skin 25 through the movement of an actuator 24. This deflection of the skin activates nerve endings at the point of creating the sensation of touch. The diaphragm within the housing 26 can be inflated in response to increased electrical signals from the robotic interface, creating an increased (or decreased when the diaphragm pressure is reduced) sensation of pressure or grip. This type of fine, gentle control creates a very close approximation of the actual sensation of touch, as if the operator were actually performing the action.

FIGS. 2D through 2F illustrate an embodiment similar to FIGS. 2A through 2C, except that the diaphragm itself 27 flexes outward and applies pressure to the skin of the operator 25.

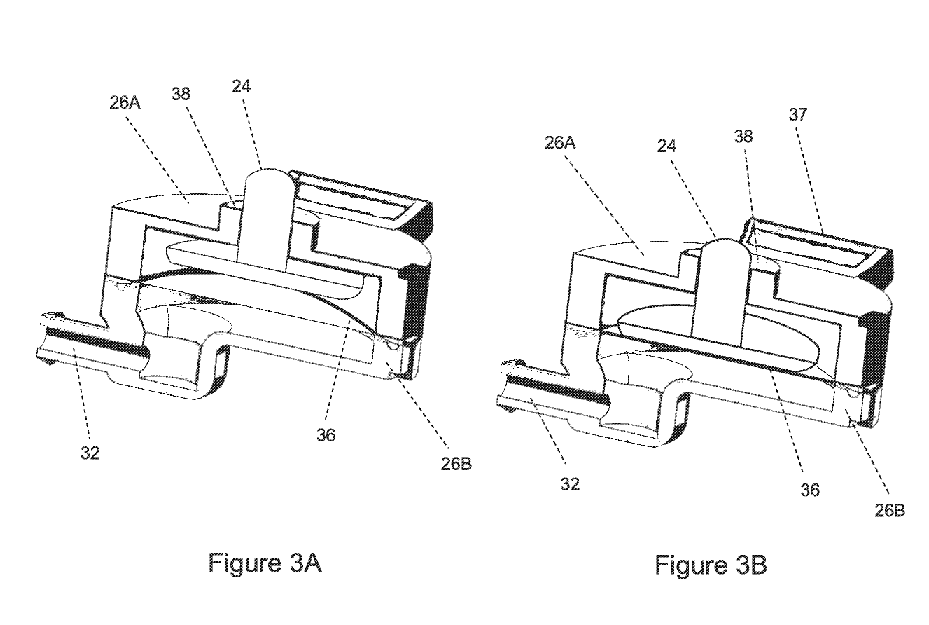

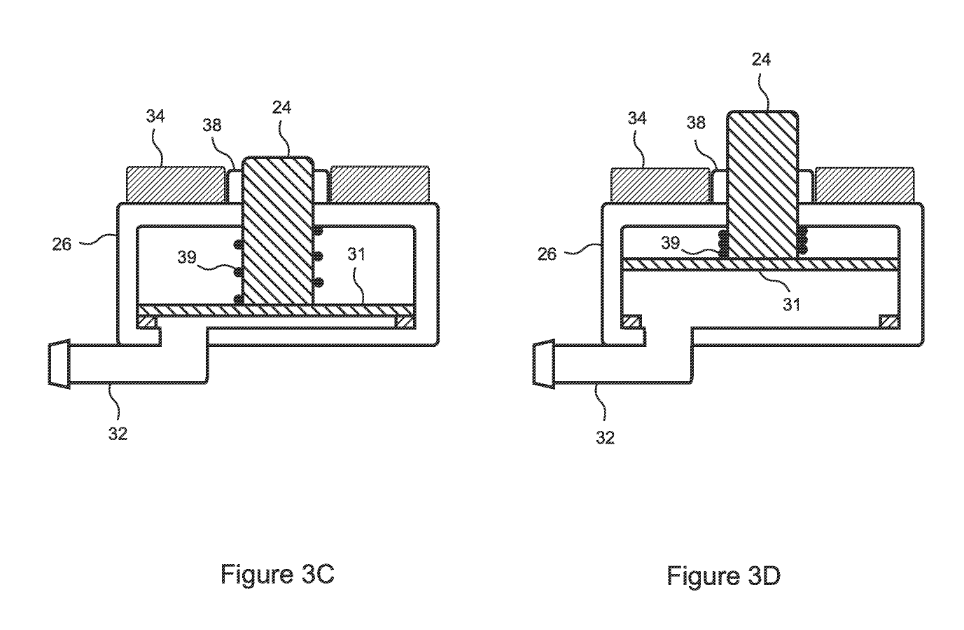

FIGS. 3A and 3B depict an embodiment of the invention in cutaway views which are meant to show the pressurized (FIG. 3A) and neutral (FIG. 3B) states of the embodiment. The embodiment includes upper and lower sections 26A, 26B separated by a diaphragm 36 so as to form upper and lower chambers. Resting on top of the diaphragm is an actuator 24. The actuator 24 moves in and out of an access port 38 as pressure under the diaphragm 36 is increased or decreased via the intake port 32. As shown in FIG. 3A, a pressure increase causes the diaphragm 36 to swell in the direction of the access port 38, forcing the actuator 24 against the skin 21 of the operator. Decreasing the pressure relaxes the diaphragm 36 and allows the actuator 24 to recede back into the upper chamber.

In the embodiment of FIGS. 3A and 3B, the force that causes the actuator 24 to recede into the upper chamber is a result of the elasticity of the operators skin pushing back on the actuator 24. In other embodiments, the actuator 24 is connected to the diaphragm 36, such that when the diaphragm 36 recedes the actuator 24 is pulled back into the upper chamber.

With reference to FIGS. 3C and 3D, other embodiments use other recession forces, such as a spring 39 configured with sufficient force to retract the actuator 24 while not unduly resisting the extension of the actuator out of the access port 38 when pressure is applied to the intake port 32. In embodiments, more than one of these mechanisms is combined to aid recession of the actuator 24.

While the actuator 24 in the embodiment of FIGS. 3A and 3B is a separate component, in other embodiments the diaphragm 36 and the actuator 24 are combined within one component, with care being taken to minimize additional frictional forces between the actuator 24 and the access port 38 walls due to torque. In the embodiment of FIGS. 3C and 3D, a piston 39 is used in place of a diaphragm 36. Some of these embodiments include one or more lubricants to minimize friction between various faces of the piston 39 and actuator 24 and the static elements of the embodiment 26, 38.

Embodiments that include a dual-chamber diaphragm system 36 have the advantage that the diaphragm will have a natural tendency to expand uniformly as a fluid (liquid or gas) is pressurized below the diaphragm, creating an even pressure which translates into a smooth linearly actuated motion of the actuator 24, while also reducing the friction to only the walls between the actuator 24 and the interior walls of the access port 38. The use of a dual chamber diaphragm 36 also allows the pressure system to be closed as the fluid under the diaphragm 36 is self-contained.

It should be noted that the diaphragm 36 in the embodiment of FIGS. 3A and 3B is held in place by the combination of a light adhesive and pressure. The two halves of the chamber 26A, 26B mate concentrically with a recessed groove (and associated raised edge) that, because of its shape, not only holds the diaphragm 36 in place, but also helps to seal the lower chamber. This approach allows for quick manufacturing and field replacement. It should be understood, however, that this is only one of many ways to design a pressure-tight closure system, all of which are included within the scope of the present invention.

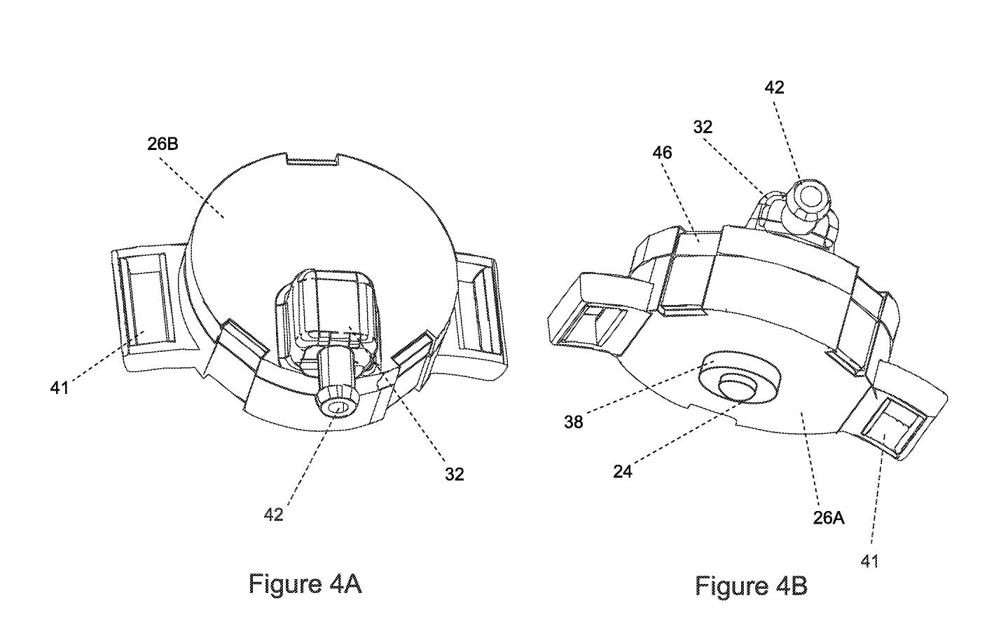

FIGS. 4A and 4B are perspective exterior views of the embodiment of FIGS. 3A and 3B. In this embodiment, the two pressure housings 26A, 26B are held together by three clips 46. These clips 46 provide the pressure that not only holds the pressure chamber together, but also traps and seals the edges of the inner diaphragm 36. Other closure devices are used in various embodiments, such as screws and threading, but clips 46 provide sufficient pressure and make manufacturing inexpensive and easy. The use of clips 46 also reduces the outer diameter of an embodiment as additional space is not required for screw seats or thread walls.

Embodiments of the present invention are designed so that the actuator 24 is pressing against the wearer's skin. When the pressure inside the pressure chamber is increased, the actuator 24 will push against the skin in proportion to the pressure being exerted by the robotic system. This allows the operator of the robotic system to not only feel the persistent pressure, but also to feel changes in pressure. Pressure is increased in the upper chamber by changing the pressure of a gas or other fluid which is fed into the chamber via a hose attached at the barbed inlet 42.

Embodiments of the present invention can be attached to the operator by a variety of means. The embodiment of FIGS. 4A and 4B includes a set of loops 41 which can be used to add a band of elastic material that can hold the bottom face of the lower chamber and the access port 38 against the operator's skin. With reference also to FIGS. 3C and 3D, note that the access port 38 includes a lip which is meant to provide enough of a gap between the actuator's neutral position and the face of the lower chamber 44 to allow for a ring of padding 34 to be affixed surrounding the access port 38, so that the operator experiences no discomfort when the embodiment is pressed against the skin. While the embodiment of FIGS. 4A and 4B includes loops 41 for a “watch band” type of attachment device, various embodiments are affixed in different ways, including a neoprene wrap, a solid clip (like a plastic headband or bracelet), or a Velcro closure wrap. The attachment mechanisms of various embodiments are designed so as not to allow the invention to twist or rise off the skin, as this will lessen the effect of the actuator.

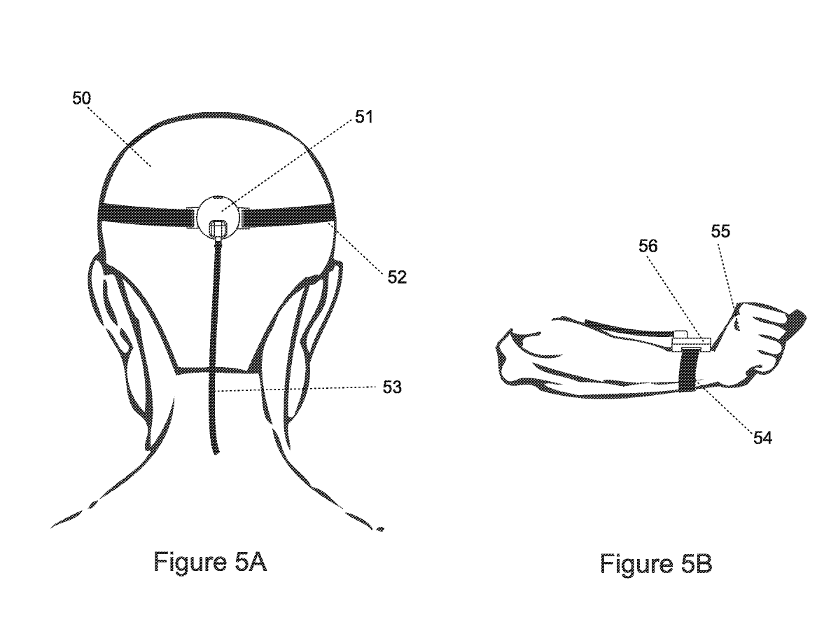

FIGS. 5A and 5B display two potential locations where embodiments of the invention can be worn by an operator. These locations are intended to place the embodiments such that they do not interfere with the operator's dexterity or touch. While providing a sense of haptic feedback is the primary intent of the invention, it is important that the resulting solution does not negatively impact the ability of the operator to perform at his or her peak capacity. In FIG. 5A, the embodiment 51 is placed on the head 50 of the operator. The operator can locate the invention 51 on or under his or her hair. One advantageous choice is that the device be located on the occipital cranial bone near the lambda region, as this is one of the most pressure-sensitive regions on the cranium. The location of the embodiment 51 at the back of the cranium also allows the pressure hose 53 to rise up the back of the operator's neck without impeding motion or placement of the operator's head into visual interaction systems. In FIG. 5A, the embodiment 51 is held in place by a band 52 which allows the device 51 location to be adjusted and/or the band 52 to be tightened.

FIG. 5B shows a device 56 attached to the wrist of an operator's arm 55, such that the device 56 is pressing on the back of the wrist or forearm. This allows the operator to wear multiple devices without hampering his or her mobility, while still being able to feel the pressure of the transducers.

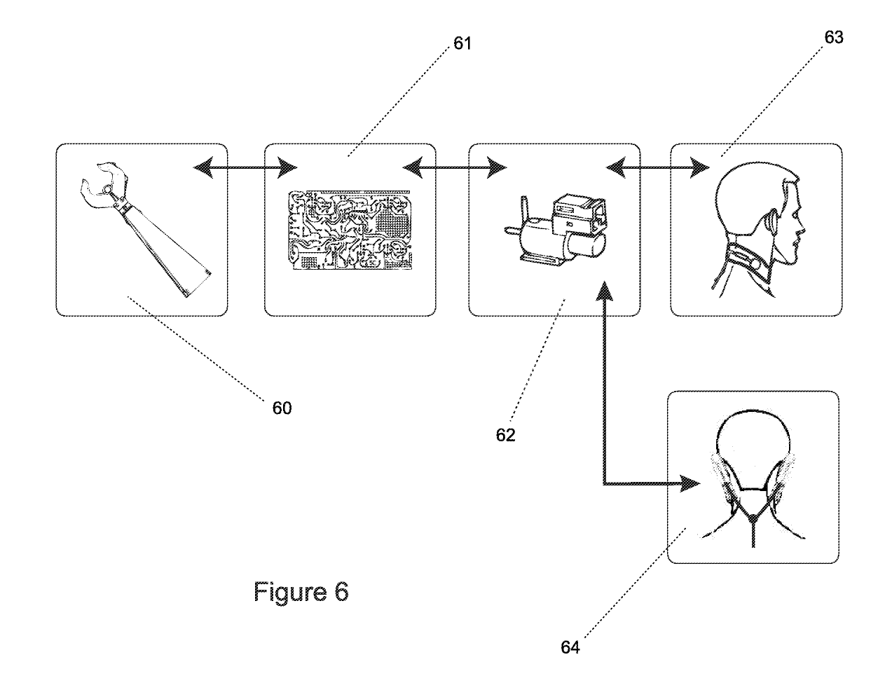

FIG. 6 provides a very high level overview of the possible system elements of an overall solution set. Shown are the four basic elements starting with the robotic or machine interfaces 60 which are normally connected to an electronic apparatus 61 which provides power and control signals for the various servos and actuators. In embodiments, the pressurization system 62 for the invention uses feedback (or direct control signals) from the electronic apparatus 61 to regulate pressure to the invention's diaphragms that are attached to the operator at a location that does not impede any required movements or dexterity of the operator. Examples of attachment locations include the neck 63 and the back of the head 64. Implementing the invention consists of crafting the diaphragms, wraps, and pressure system, which are then interfaced with the existing electronics 61.

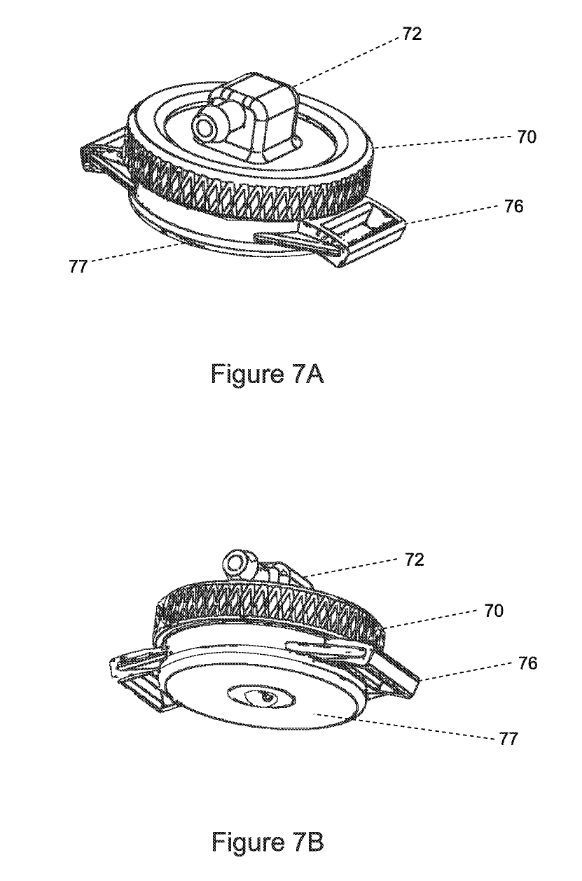

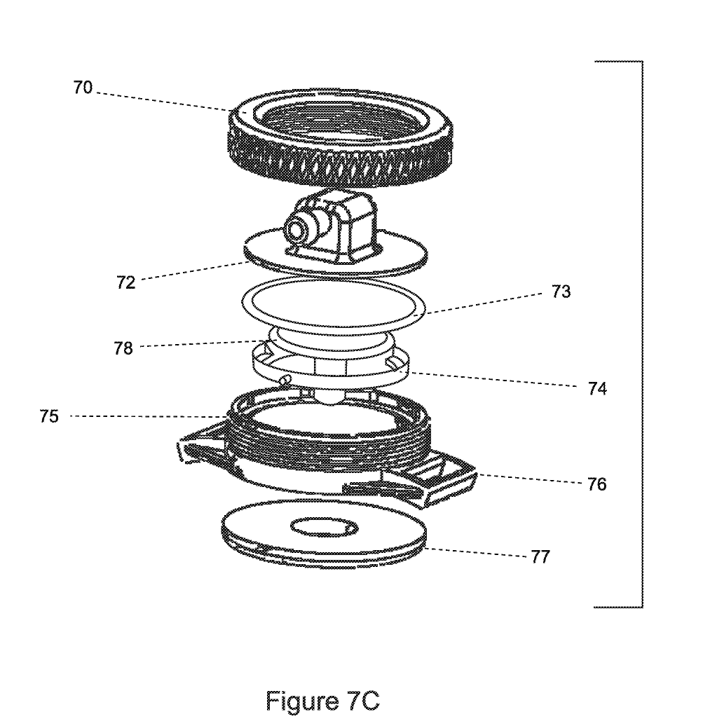

FIGS. 7A through 7C depict an embodiment of the invention that provides for adjustment of the throw of the plunger 78. The embodiment includes a threaded cap 70 attached to a threaded base 75. A pressure inlet cap 72 is held in place by the threaded cap 70, and presses an edge ring of a diaphragm 73 into a channel 75 in the top of the threaded base, so that a seal is created between the pressure cap 72 and the diaphragm 73. A plunger 78 is located immediately below the diaphragm 73 and held in place by a throw ring 74 that sits in the threaded base 75.

When pressurized air (or nitrogen) is applied to the pressure inlet cap 72, the pressure is contained in a chamber above the diaphragm 73, thereby causing a downward deflection of the diaphragm 73 that pushes the plunger 78 down through the threaded base 75 and against the skin of the wearer. The throw distance of the plunger 78 is limited by contact with the throw ring 74, and can be adjusted by the setting of the throw ring 74. Under the threaded base 75, between the wearer and the bottom of the base 75, is a cushioning material 77 which provides a more comfortable fit. In the embodiment of FIGS. 7A-7C, the threaded base 75 is also fitted with a set of reinforced band clasps 76 on either side, similar to the clasps that attach a watch band to a wrist watch. Depending on the attachment mode in various embodiments, there may be one or more of these attachment clasps 76.

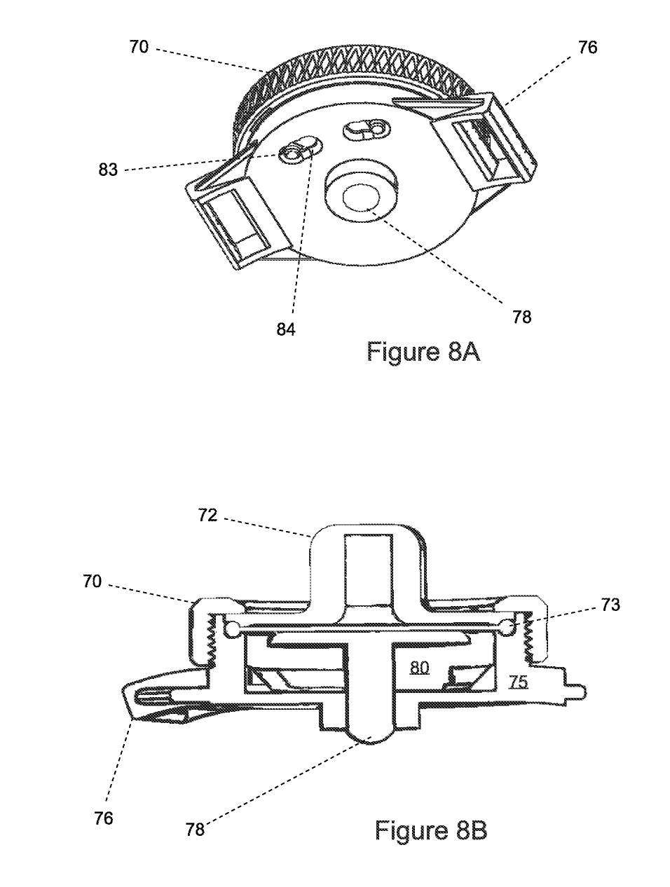

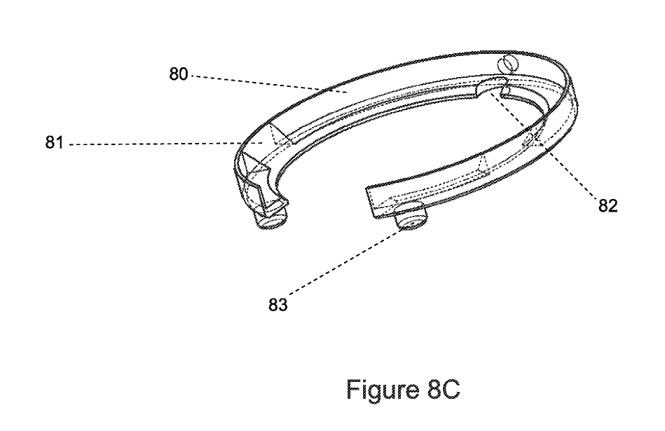

FIGS. 8A through 8C illustrate an embodiment similar to FIGS. 7A-7C, except that the throw ring 80 can be adjusted by moving tabs 83 protruding from the bottom of the threaded base. In the embodiment of FIGS. 8A-8C, three adjustments 84 are possible. By sliding the tabs 83 between these three positions 84, the inclines 81 built into the ring 80 prevent the plunger 78 from approaching the bottom of the threaded base 75, thereby shortening the throw distance of the plunger 78. The throw ring 80 contains a hinge area 82 which provides for flexibility in both directions. In similar embodiments, the throw distance of the plunger 78 is controlled with set screws that are adjusted from the top, sides or bottom. The internal throw ring 80 provides for a completely encased design without any protrusions which might catch on material.

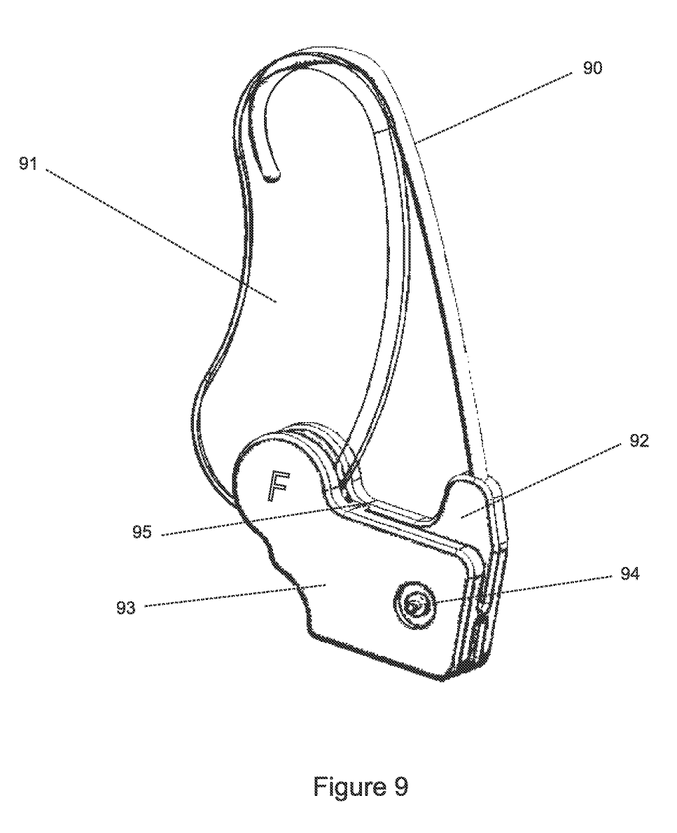

FIG. 9 is a perspective view of an embodiment which attaches to the ear 91 of an operator of robotic apparatus. The embodiment includes a clip portion that clips to the lobe of the ear 91, aided by a retaining hoop 90 which is attached to the clip portion by a rotatable pivot 92 and loops over the top of the ear to provide stabilization and support for the additional subcomponents of the embodiment. The clip portion applies pressure to the location on the ear 91 it is grasping (such as the ear lobe) by squeezing together two plates 93 and 95 using a lever motion activated by a bladder 94.

The bladder 94 expands and contracts with the application of pressure from a fluid (gas or liquid) applied to a bladder inlet, causing the plates 93 and 94 to separate on the outer portion of a hinge 95, which in turn causes the appendage, in this case an ear 21, to feel pressure that is proportional to the fluid pressure.

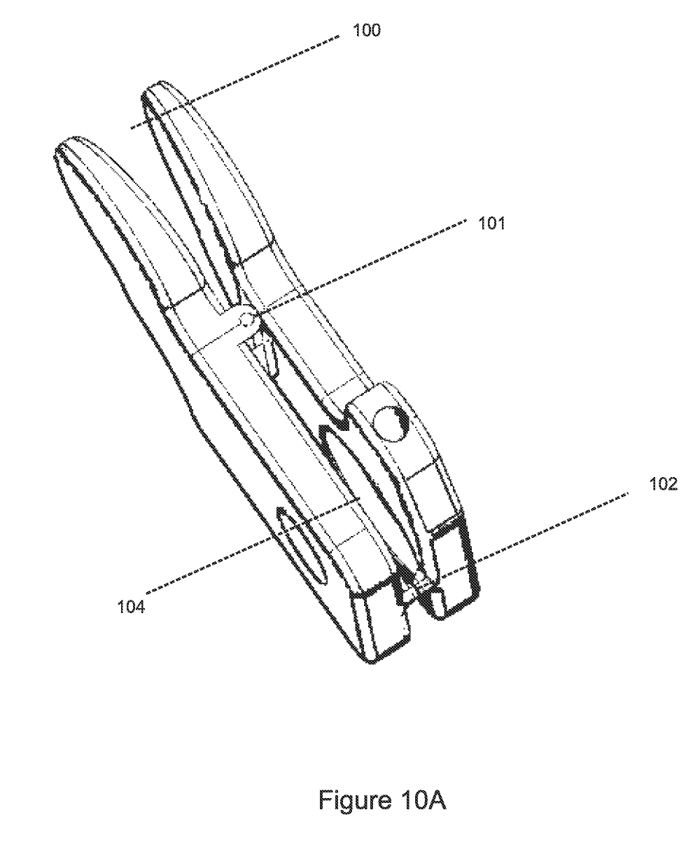

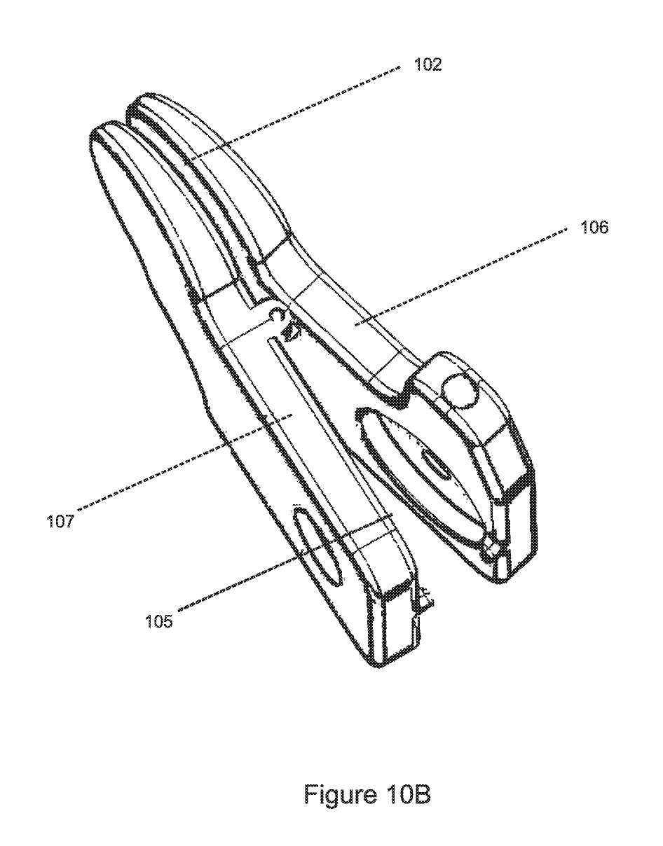

FIGS. 10A and 10B illustrate in further detail the operation of the clip in embodiments of the invention similar to FIG. 9. The two halves 106, 107 of the clip are attached by a hinge 101 that allows the halves 106, 107 to move in a scissor motion based on whether the gap between the back ends of the halves 106, 107 is more closed 104, as shown in FIG. 10A, or more open 105, as shown in FIG. 10B. When the gap is more closed 104, as shown in FIG. 10A, the contact gap is open 100, minimize the pressure on the operators appendage. When the gap is more open 105, the contact gap 102 is more closed, causing an increase in pressure on the operator's ear, or other appendage. The range of the pressure applied is controlled by the hinge 101 size, and by a spacer 103 which keeps the rear gap from closing too far. Note that the contact surfaces of the halves, 106, 107, are angled, so that when the gap is closed 102, the contact surfaces are parallel to each other and each surface is in maximum contact with the operator's skin.

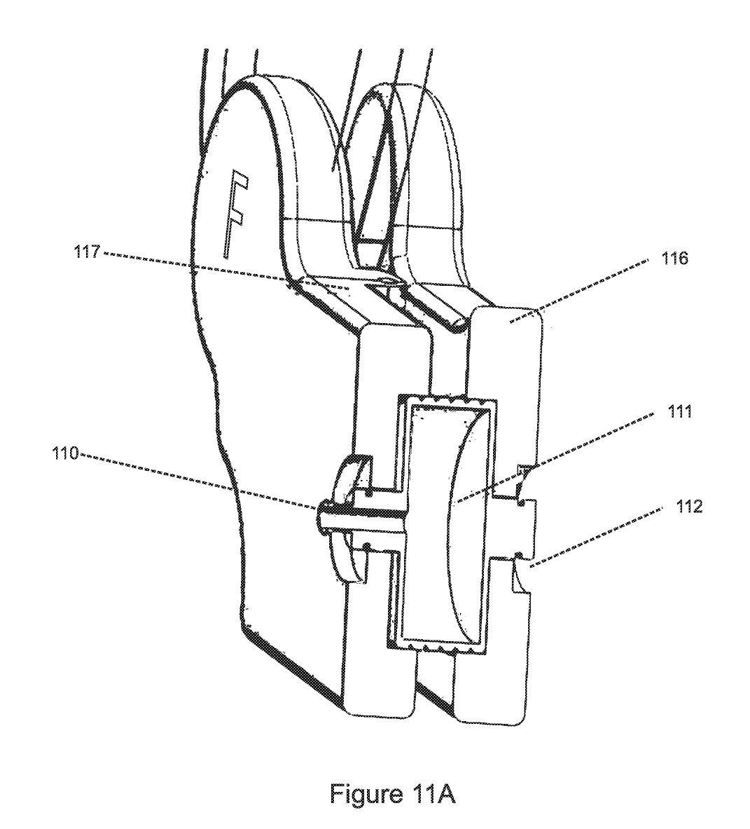

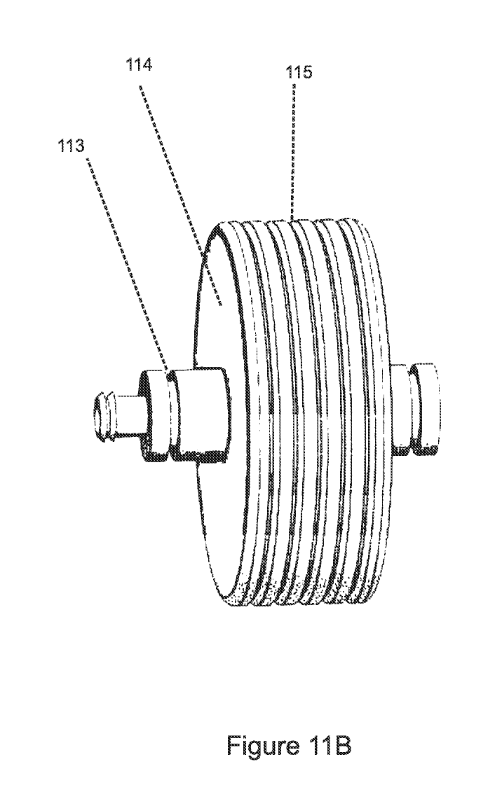

With reference to FIGS. 11A and 11B, FIG. 11A is a perspective sectional illustration of the embodiment of FIGS. 9, 10A, and 10B, with the cut taken through the bladder 114 which is used to expand and contract the gap between the rear ends of the two halves of the clip, 116 and 117. The bladder 114 includes collapsible baffles 115 which allow the bladder 114 to expand and contract when pressure is applied by a fluid to the bladder inlet 110. When the pressure of the fluid is increased in the interior 111 of the bladder 114, the bladder 114 expands in length, causing the space between the two back halves 116, 117 of the clip to expand. This causes the contact surfaces to squeeze together, increasing the pressure on the operator's skin.

FIG. 11B is a perspective view of the bladder 114 of FIG. 11A. When the fluid pressure is reduced, the bladder 114 retracts in length. The gap between the rear halves of the clip 116, 117 is thereby reduced, and the pressure on the operator's skin is reduced, because the rear clip halves 116, 117 are attached to the ends of the bladder 114 by retaining clips which fit into clip notches 113 in the ends of the bladder 114. The bladder 114 is placed between the rear portions of the two clip halves, 116 and 117, with the center hub of the bladder 114 protruding through holes 112 in the two rear halves. Clips are then fitted into the notches 113 in the hub of the bladder 114 on the outside of each clip half, 116 and 117, so that when the bladder 114 pressure decreases, the contraction of the bladder 114 causes the gap between the two halves, 116 and 117, to close. The clips also help retain the bladder 114 within the invention and facilitate replacement of the bladder in the field.

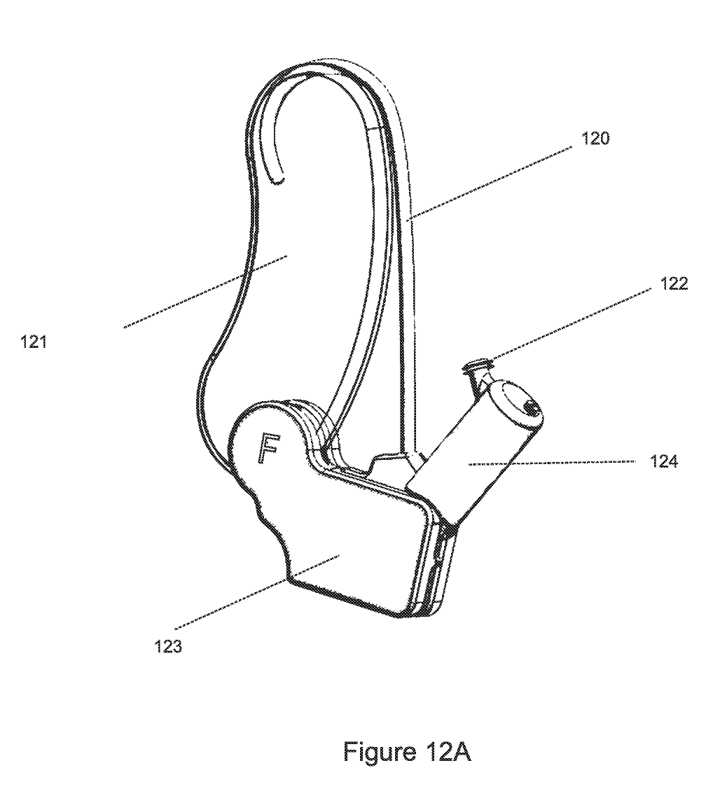

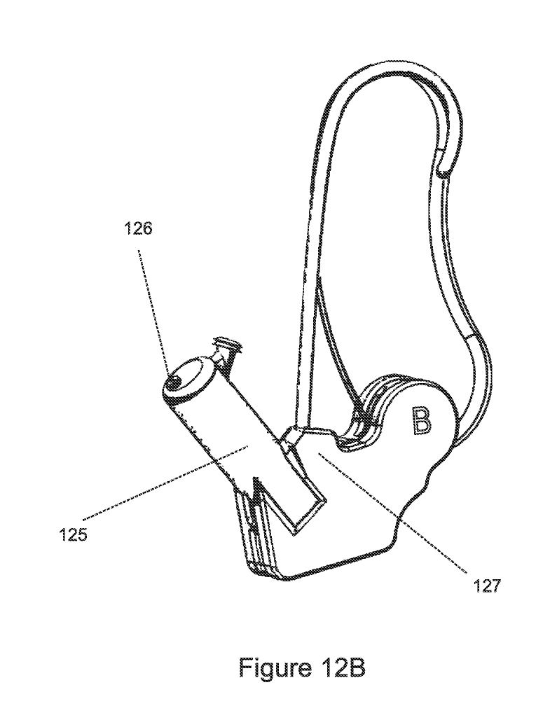

FIGS. 12A and 12B are perspective view from the left and right respectively of a clip-on haptic device embodiment of the present invention that is similar to the embodiment of FIG. 9 except that it employs the use of a piston wedge rather than a bellows 114 to expand the gap between the rear portions of the clip halves, and thereby to translate fluid pressure to mechanical pressure applied to skin of the operator. As with the embodiment of FIG. 9, the embodiment of FIGS. 11A and 11B hangs over the operator's ear 121 by use of a hanging loop 120. The hanging loop 120 supports a clip made of two halves, 123 and 127 which are joined by a hinge. The pressure exerted by halves, 123 and 127, is controlled by the use of a piston 125, whose movement is provided by pressurized air or another fluid injected into a piston inlet 122. The piston 125 travels linearly, driving a wedge into the gap between the two clip halves, 123 and 127, and thereby causing the device to apply pressure to the operator's ear.

The range of pressure applied is adjusted using a set screw 126 in the top of the piston housing. This controls the distance that the piston travels, and thus the amount of the wedge that is pushed into the gap. Additional set screws control other ranges of motion as needed in various embodiments. Upon reduction of the fluid pressure, the return of the clips to the minimal gap configuration is provided by a reverse pressure on the clip applied by the operator's lobe, and by a return spring included in the hinge.

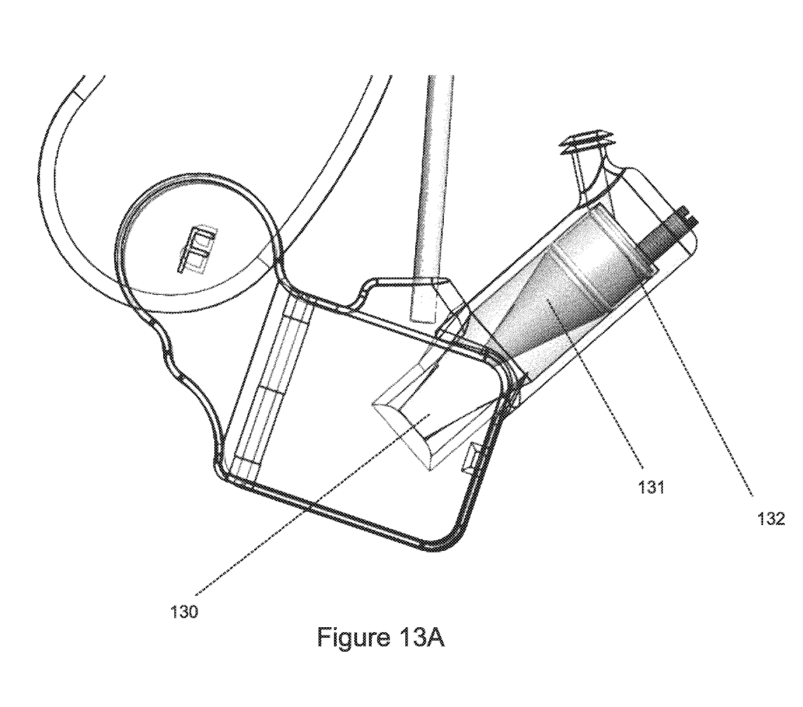

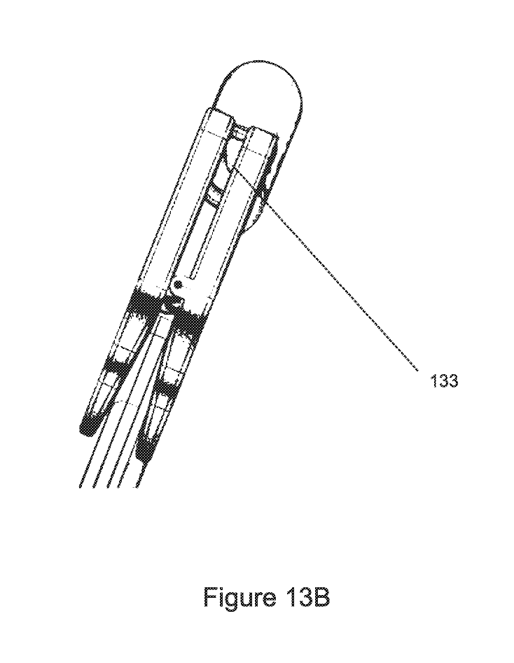

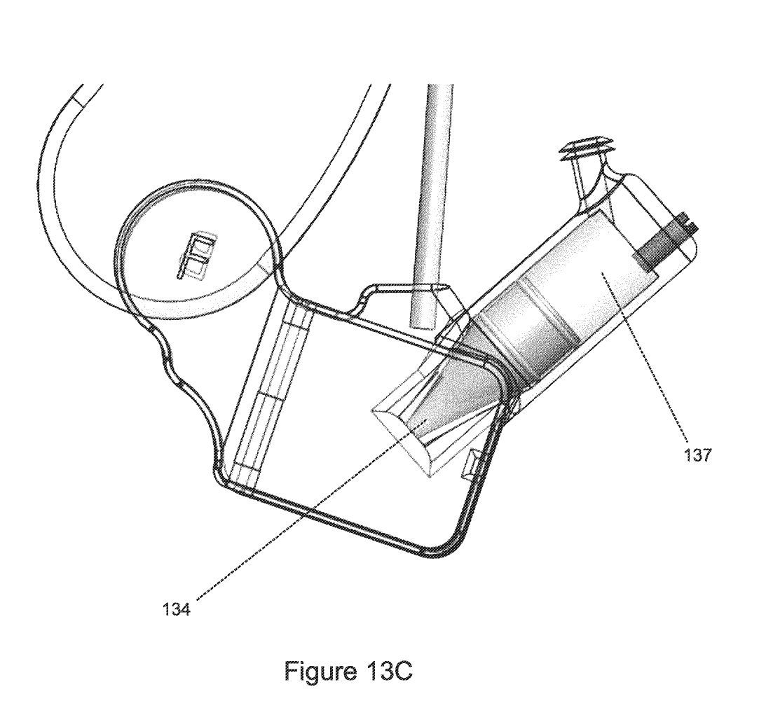

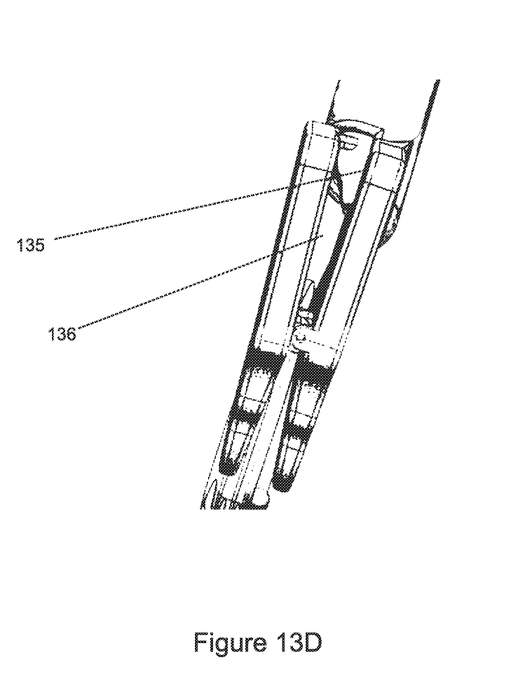

FIGS. 13A through 13D further illustrate the action of the wedge piston 131 of FIGS. 12A and 12B. The wedge piston 131 has a conical tip that travels along a depression in one of the clip halves. As the pressure is increased in the chamber 137 above the piston 131, the piston 131 moves from a fully retracted position 130 down into the gap 133 between the clip halves 135, causing them to separate 135. This causes the front halves of the clip to squeeze on the operator's ear. FIGS. 13A and 13B are side and rear views respectively of the device in its zero-pressure configuration. FIGS. 13C and 13D are side and rear views respectively of the device in a fully engaged configuration, with the wedge 131 fully extended 135 and the device applying its maximum pressure to the operator's ear.

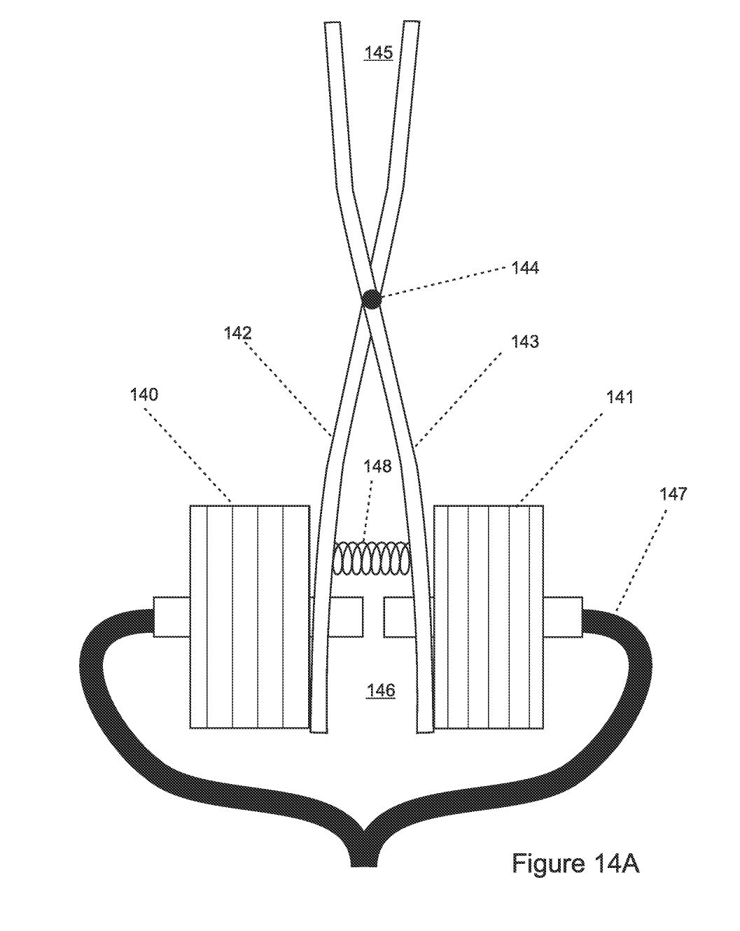

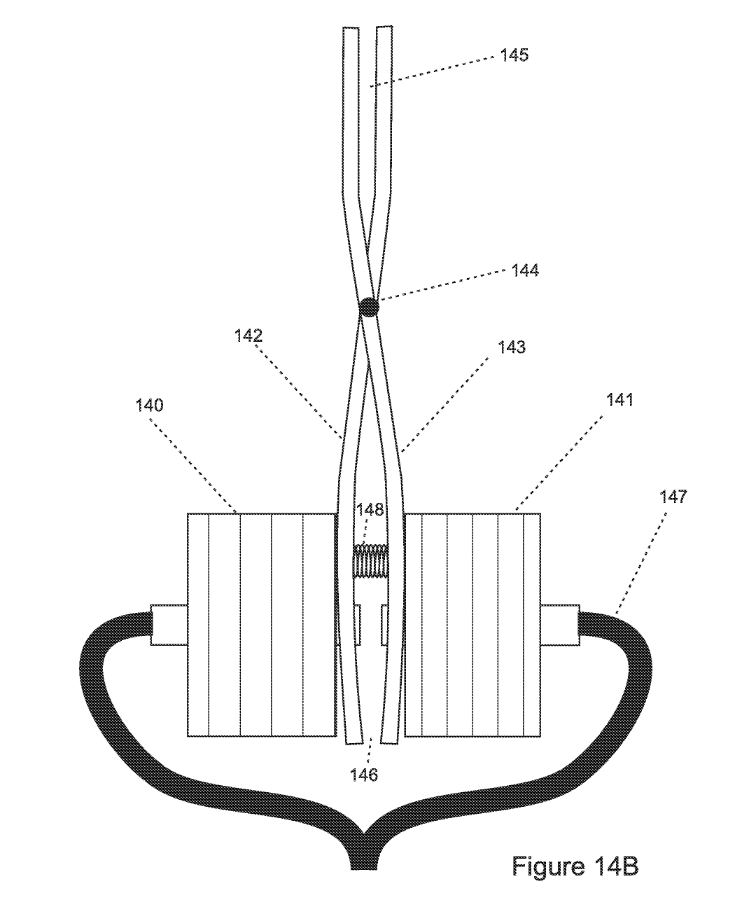

FIGS. 14A and 14B are side views of an embodiment similar to the embodiment of FIG. 9, but having two halves 142, 143 coupled by a hinge 144 in a “scissors” configuration in which the forward gap 145 is directly proportional to the rear gap 146, rather than being inversely proportional as in the clip configurations of FIGS. 9 through 13D. The embodiment of FIGS. 14A and 14B is driven by a pair of bellows 140, 141 which are supplied with fluid from a common source 147 and driven apart by a spring 148 when the fluid pressure subsides. For simplicity of illustration, the ear hook or other attachment mechanism has been omitted from the figures.

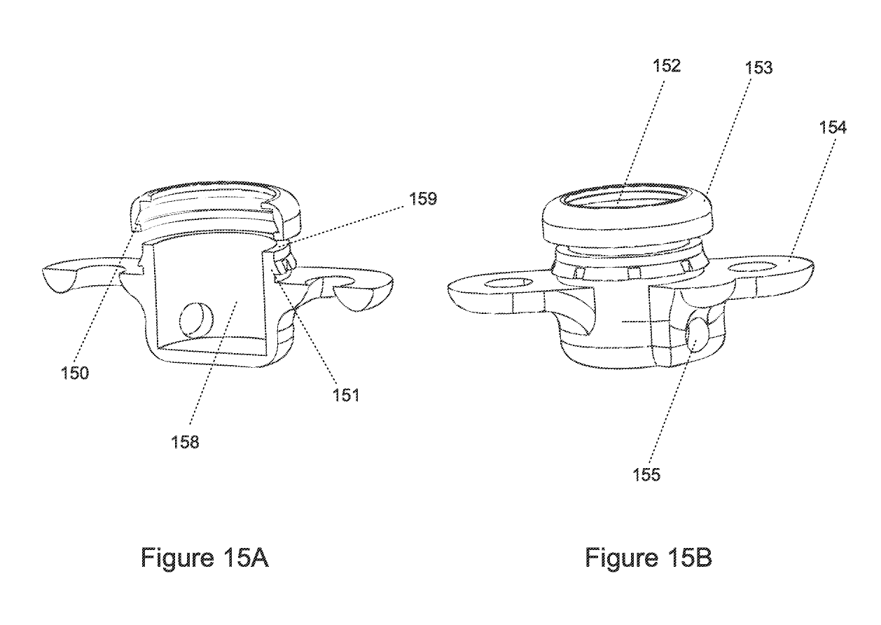

FIGS. 15A and 15B are cutaway and complete perspective views, respectively of an individual pressure transducer in yet another embodiment of the present invention. Each transducer consists of a pressure chamber 158 which is fed by an intake 155 which connects to a centralized pressure chamber. The pressure chamber 158 is closed by a snap-on cap ring 153 which snaps over a flexible diaphragm 152, creating a pressure-tight seal. The cap ring 153 has an inner lip 150 which slides over the lip 151 of the transducer, creating a compressive pressure along the lip 159 which holds the diaphragm 152 in place. With flexible diaphragm material, like latex, it is recommended that a snap-on or glued cap be used. If a screw on cap it used, the diaphragm should be made of a rubberized material so that when the cap is screwed on the diaphragm is not deformed.

Furthermore, the transducer shown in FIGS. 15A and 15B has extended through-hole surfaces which allow the transducer to be affixed to the wrap material using a variety of methods, including but not limited to sewing, riveting, snapping, or adhesion. What is important is that the material the transducer is affixed to be rigid enough not to deform or twist when the diaphragm expands against the operator's skin.

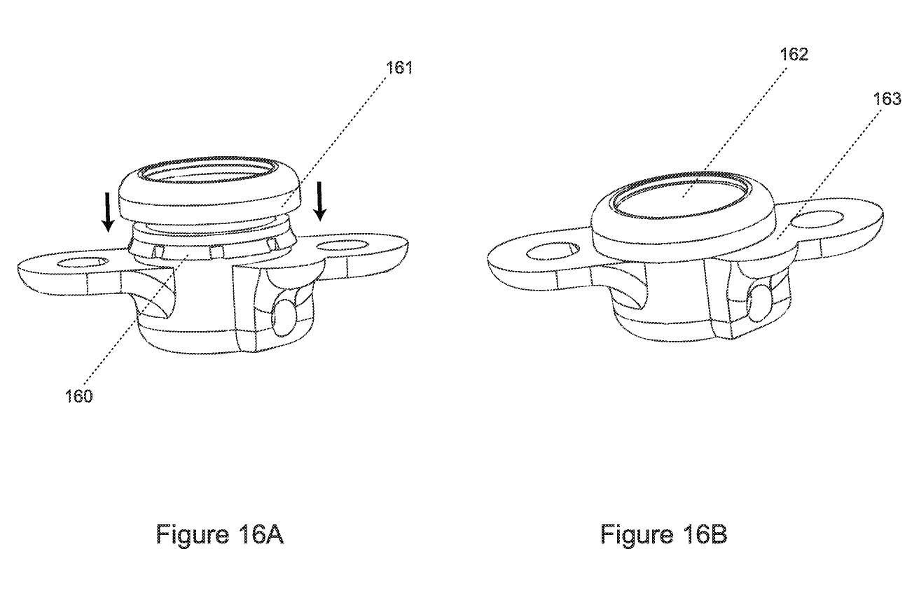

FIGS. 16A and 16B illustrate in further detail the concept of the pressure vessel cap 161 in the embodiments of FIGS. 15A and 15B. The cap 161 is designed to snap over the pressure vessel 163 such that it pulls the diaphragm material 162 taunt. The cap should click down over the retaining clips 160 in the pressure vessel 163 and fit snugly, so that there are no gaps on which the complete apparatus could catch and potentially loosen the pressure-tight seal. Preferably, the cap 161 should be designed to be a one-time fit, as it will be hard to remove the cap 161 without damaging the diaphragm 162. It may also be feasible to include a capillary adhesive which will further seal the vessel but will not create a buildup which would cause pressure leaks. Cost of materials should support a replacement strategy that simply requires complete replacement of the apparatus by simply removing it from the pressure hose and installing a new one in its place.

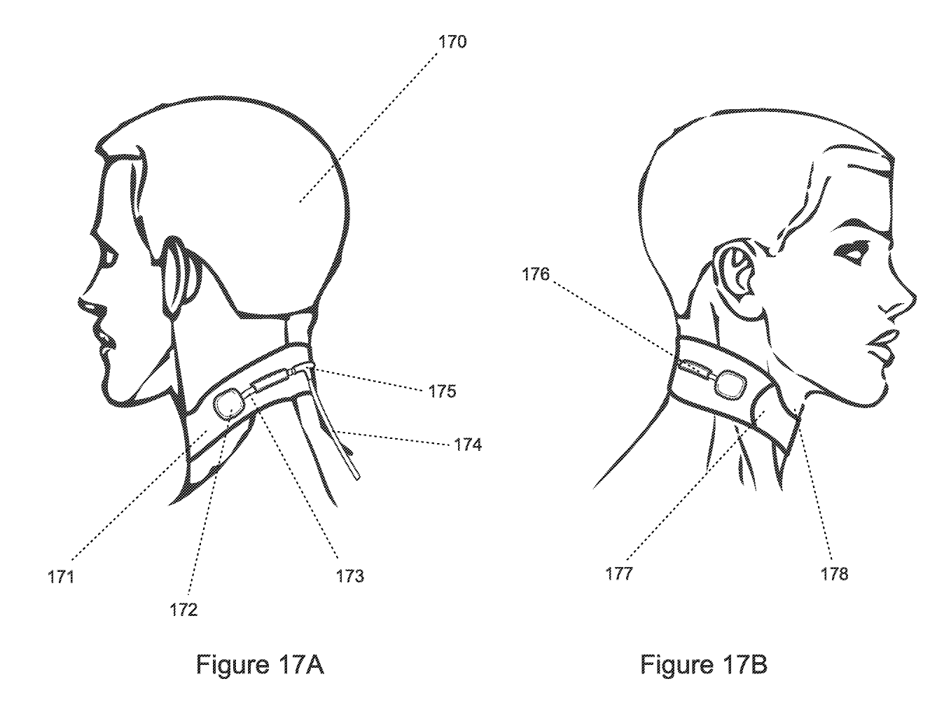

FIGS. 17A and 17B illustrate in further detail the concept of using a wrap 171 to house and attach a transducer apparatus such as the one shown in FIGS. 15A and 15B, or another transducer of a suitable embodiment. While wraps can be used in any location on the operator 170, the neck is a primary location since it does not impact the operator's hands, and the use of a flexible but firm material allows the operator freedom to interact. The neck wrap 171 shown in FIGS. 17A and 17B has transducers mounted on both sides of the neck underneath the pocket material 172. These transducers could be used in concert, for example to emulate a squeezing motion, or separately as two different touch indicators. The use of two transducers is simply provided to illustrate the flexibility of design, quantity, and placement. Depending on the location on the operator 170, there could be several transducers attached, for example on the operator's 170 forearm.

In the case of a neck wrap 171, the transducers in the placement pockets 172 are pressure transducers, and are connected to pressure lines 173, which slip through a guide 176 and connect to a vertical pressure feed line 174 using a T-connector 175. If the transducers are to be controlled independently, there can be more than one set of pressure lines or pressure regulators attached to the main pressure line. The neck wrap is closed on the front-side 177 of the operator's 170 neck to allow for adjustment (loosen or tighten), and to avoid manufacturing complexity with the pressure lines and transducers. The neck wrap 171 also has a lowered cut out in the front that provides comfort and freedom of motion.

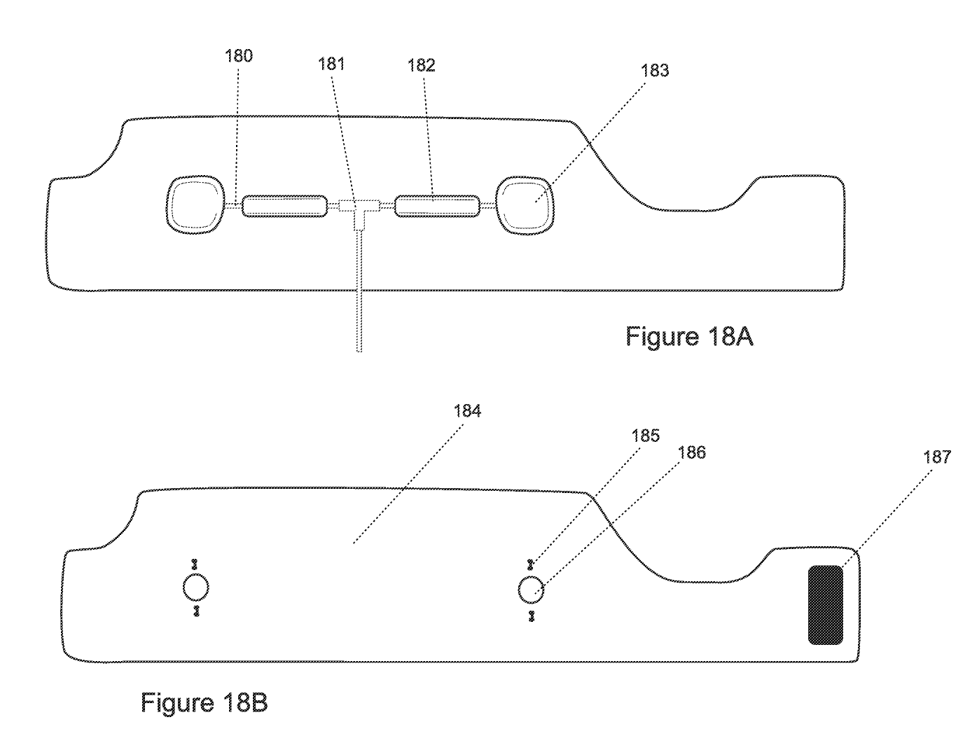

FIGS. 18A and 18B illustrate in further detail the neck wrap 184 of FIGS. 17A and 17B as it appears when it is not attached to an operator, so as to clarify basic manufacturing techniques and design elements. In the embodiment of FIGS. 18A and 18B, the transducers are located underneath the pockets 183, which can be attached in various methods (sewn, glue, Velcro, etc.), shown here as sewn on cloth patches with the pressure line tube 180 entering through a partially sewn side. This design also allows manually replacement of the transducers without sacrificing placement. On the inside of the neck wrap 184 there are holes 186 in which the transducers elements sit, allowing them to be placed up against the skin of the operator. Also noted are stitching locations 185 for embodiments where the transducers are sewn in. Note that the transducers are mounted vertically in order to allow the wrap 184 to adhere to the curvature of the neck. This assumes that the transducers are built using a two-wing configuration as previously shown.

The pressure lines 180 to either side of the neck are run through guides 182 which are designed to keep the pressure lines 180 in place without crimping or buckling. The guides 182 can be attached via any method, but are shown sewn on in the figure. The pressure lines 180 come together at a feed line, where they are connected using a T-shaped fitting 181. The wrap itself can be held closed using a hook-and-loop material such as Velcro 187, or by any other adjustable closure method known in the art.

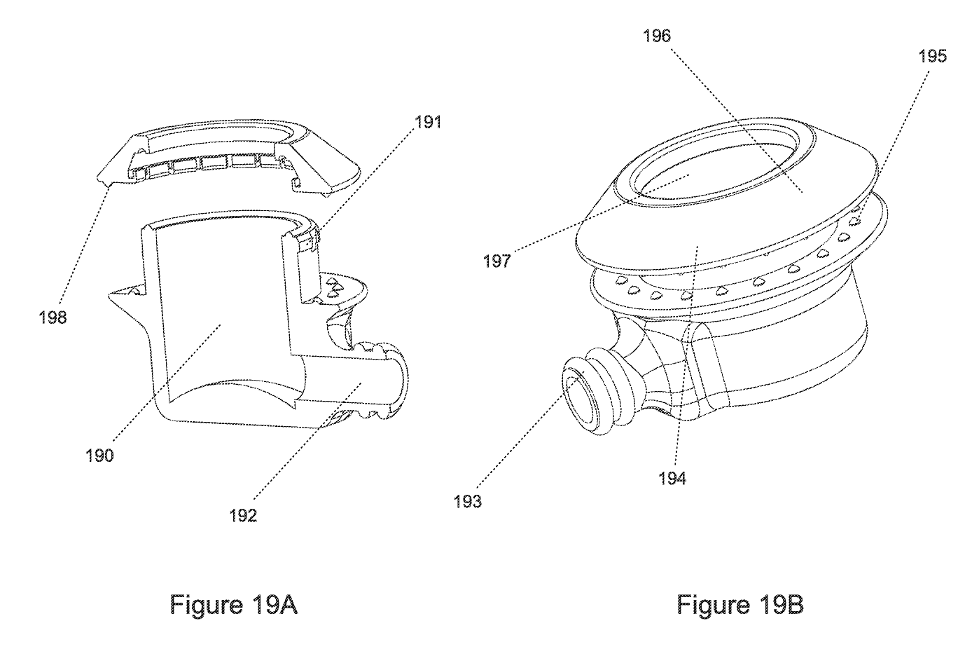

FIGS. 19A and 19B depict a transducer design of yet another embodiment of the present invention, and a method of assembling the transducer such that both the diaphragm and the fabric material of the wrap worn by the operator (neither being shown in this figure) are crimped between the lower surface 198 of the snap-on cap 196 and the upper surface 195 of the base 190. The cap 196 snaps over the base 190 by gripping the underside of the closure tab 191. The base 190 is first fit through a hole in the fabric material of the wrap and is then fixed in place by disposing the diaphragm over the opening 197 of base 190 and snapping the cap 196 on over the diaphragm. This snap closure action not only pulls the diaphragm material tightly over the opening 197 of the base 190, but also compresses the diaphragm edge material and the wrap fabric material between the two gripping surfaces, which are studded with teeth to add friction. In embodiments, the distance between the lower grip surface 198 of the cap and the upper grip surface of the base 190 when the snap cap is fully engaged compress the two layers of material to at least 30% for a tight fit, although choice of fabric and diaphragm materials and the contours of the gripping surfaces of the cap and base may permit minimal compression. This method of assembling the transducer can eliminate the need to sew or glue the unit to the fabric.

In other related embodiments, the diaphragm attachment may be a separate process executed before or after the snap-action attachment of the transducer to the wrap fabric. Mounting of the diaphragm to or in the opening 197 may or may not use adhesive or other attachment means. The edge of the diaphragm extends in some (but not all) embodiments over closure tabs 191 and into the gap between surfaces 195 and 198. For example, the diaphragm can comprise a flat disc secured over opening 197, or a balloon or bladder installed within the cavity of base 190, and can be installed before or after the transducer base 190 is inserted into a hole in the wrap fabric.

The pressure line is attached to the input nozzle 193, which in this embodiment has two fitted rings that help retain the pressure line. The pressure line provides air into the central chamber of the base 190 through the inlet 192, which causes the diaphragm to expand and relax, extending and retracting in the manner described elsewhere herein.

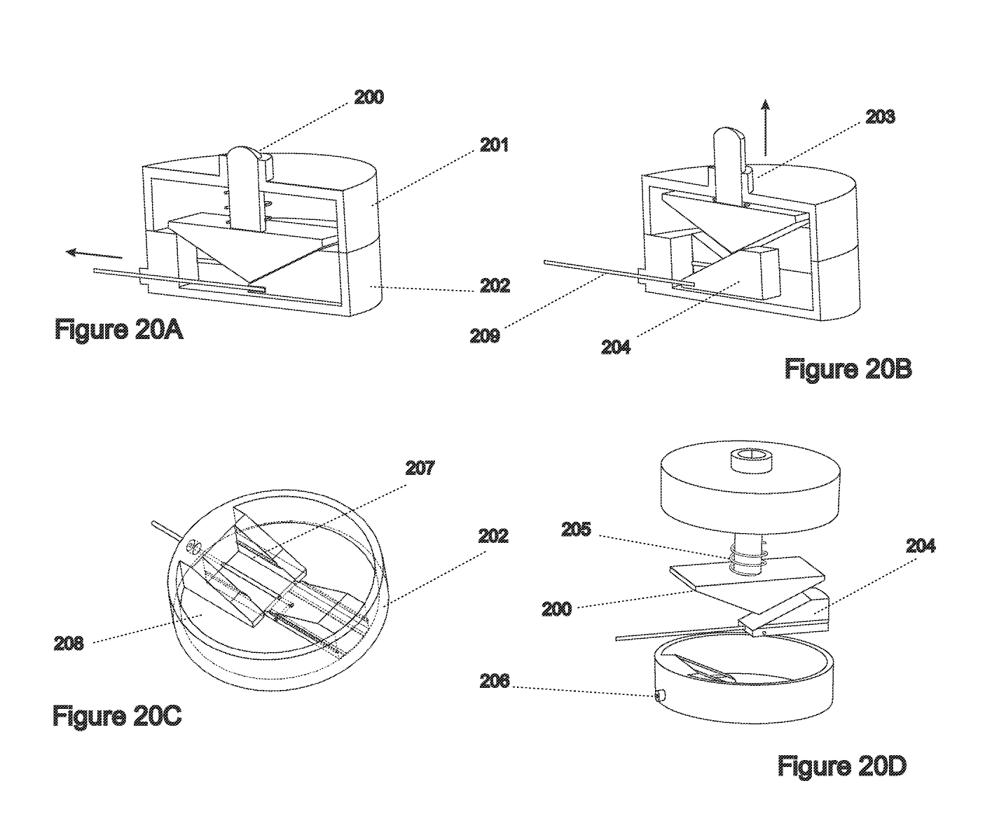

FIGS. 20A, 20B, 20C, and 20D depict the use of a wire-controlled transducer which uses the mechanical action of a guide wire 209 to move a piston 200 through the action of a wedge 204 moving against an inclined plane of the piston 200. The guide wire 200, which is threaded through a hole 206 in the outer casing 202, pulls the wedge 204 towards the middle of the lower chamber 208, which closes the gap between it and the stationary wedge 207. As these wedges move together, the inclines on the bottom of the piston 200 move the piston up through the access hole 203 located in the top casing 201 of the embodiment. The return action of the piston 203 is aided by the elasticity of the skin against which it is pressed. In the embodiment of FIGS. 20A through 20D, this return action is further enhanced by the action of a return spring 205.

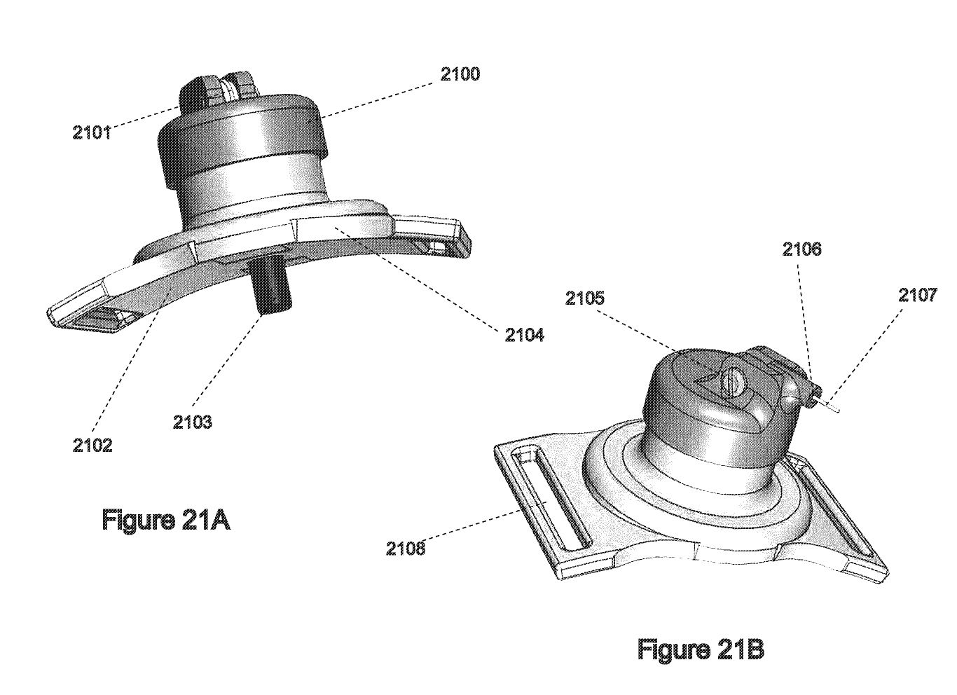

FIGS. 21A and 21B are two perspective views showing the external features of an embodiment of the present invention, where FIG. 21A is shown from the top and FIG. 21B from the bottom. The embodiment of FIGS. 21A and 21B is designed to be worn on any location of the operator, being affixed by a strap or sleeve which keeps the mating surface 2102 in contact with the operator's epidermis. The mating surface 2102 can be designed to conform to any curvature as long as the surface 2102 maintains constant contact with the operator's skin at the egress point of the actuator 2103. The invention includes a chamber 2104 in which an actuator 2103 is encapsulated. The actuator 2103 moves up and down within the chamber 2104, causing it to exert more or less force on the skin of the operator.

The chamber 2104 is sealed by a cap 2100 through which a control wire 2107 enters the chamber 2104 and attaches to the top of the actuator 2103. The control wire 2107 enters the cap 2100 through a guide hole 2106 and wraps over a bearing 2101, which is held in place by a retaining screw 2105 that also acts as the axis on which the bearing 2101 rotates. The control wire 2107 curves over the surface of the bearing 2101, allowing it to move in and out through the guide hole 2106. The movement of the control wire 2107 causes the actuator 2103 to rise or fall within the chamber 2104, which in turn increases or lessens the actuator's 2103 pressure on the operator. The invention is held in place by attaching a strap to the chamber base 2104 through strap guides 2108.

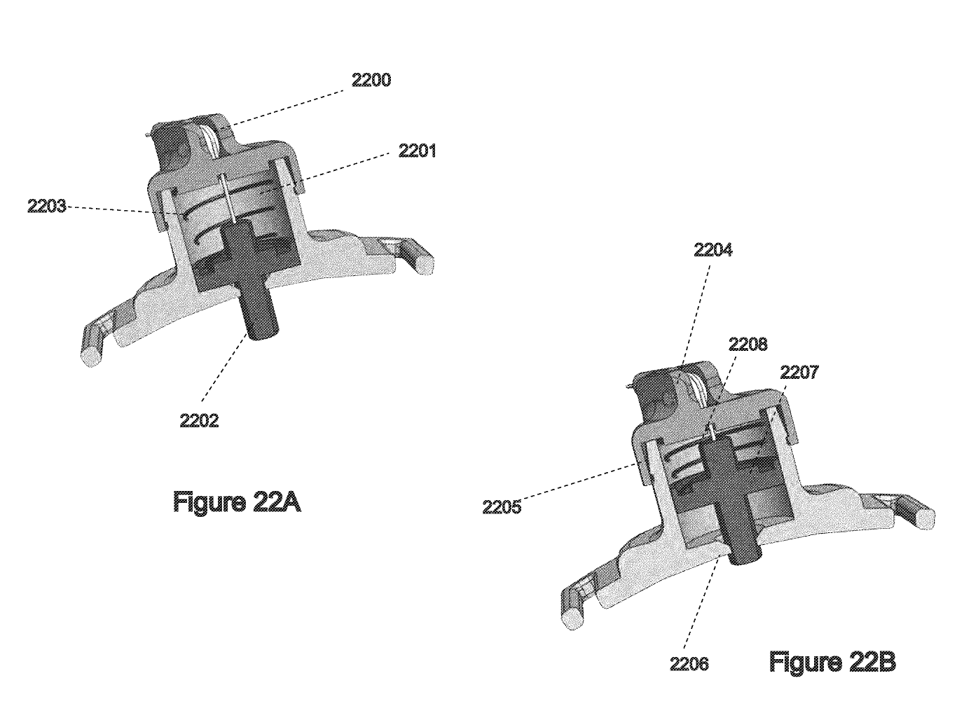

FIGS. 22A and 22B present two cut-away views revealing the internal components in an embodiment of the present invention, the plunger 2202 being fully extended in FIG. 2A and fully retracted in FIG. 2B. The embodiment includes an inner chamber 2201 in which the actuator 2202 moves. Above the actuator 2202 is a spring 2203 which exerts force on the top of the actuator 2202, causing it to extend through the bottom of the chamber 2206 and press against the operator's skin. The pressure applied by the spring 2203 is controlled by the control wire 2200. When the control wire 2200 is relaxed, the spring 2203 expands and pushes the actuator 2202 out of the bottom 2206 of the chamber. When the control wire 2204 is contracted, the spring 2205 is compressed, and the control wire 2204 pulls on the actuator 2202, causing it to retract and lessening the force exerted on the operator's skin.

The spring 2203 in the embodiment of FIGS. 22A and 22B is formed so that it sits in a channel in the top of the actuator 2202. This channel keeps the base of the spring 2203 from shifting as it is compressed. The spring coils are tapered in the embodiment of FIGS. 22A and 22B, so that the coils of the spring 2203 sit within each other as the spring 2203 is compressed, allowing the spring 2203 to be compressed to its minimum thickness. This keeps the coils of the spring 2203 from stacking and restricting the top-end position of the actuator 2202, so that the actuator 2202 can travel over nearly the full distance available within the chamber 2201.

The base of the chamber 2206 is also tapered in the embodiment of FIGS. 22A and 22B to provide a means of realigning the actuator should it be retracted too far within the chamber 2201. In similar embodiments, such over-actuation is addressed by designing the length of the actuator so that it's length is slightly greater than height of the chamber 2201, where the length of the actuator 2202 is defined as being the distance from the top of the actuator 2202 where the control wire 2204 attaches, to the bottom of the actuator 2206 which rests against the operator's skin, and the height of the chamber 2201 is defined as the distance from the bottom of the affixed cap to the lower surface of the chamber 2201.

The control wire 2204 can be affixed to the top of the actuator through any means known in the art, including but not limited to adhesives, a ferule, or a retaining screw. In embodiments the height of the top portion 2208 of the actuator 2202, which is the section above the central guide plate 2207, is long enough to allow for the spring 2205 to rest completely compressed plus a small allowance for coil stacking.

In embodiments, the length of the actuator below the central guide plate 2207 is equal to the sum of the thickness of the bottom of the chamber 2201 and the desired range of actuation movement against the operator's skin. Research has shown that an actuation distance of 0.25 to 0.33 inches normally suffices to provide both a soft and a strong tactile sensation, where soft tactile sensation is defined as a pressure in the range of 3-4 grams of force against the skin, and strong tactile sensation is defined as pressure in the range of 20-25 grams of force against the skin. These figures are derived from affixing the invention to locations on the body where subcutaneous deposits are minimized, such as the frontal or parietal regions of the skull.

It is important to note that the area over the top of the bearing is open. This allows the wire 2208 to flex, should there be any issue with the movement of the control wire 2204 through the guide hole. If for some reason the control wire 2204 could not be retracted as the actuator 2206 was withdrawn, the control wire 2204 would simply rise in the notch, thereby taking up any unused slack in the control wire 2204. In other embodiments this guide is completely enclosed, and in other embodiments entry for the control wire 2204 is vertical, and does not use any form of bearing. Embodiments of the invention use the bearing to allow the control wire 2204 to approach the invention along a direction that is substantially parallel to the operator's body.

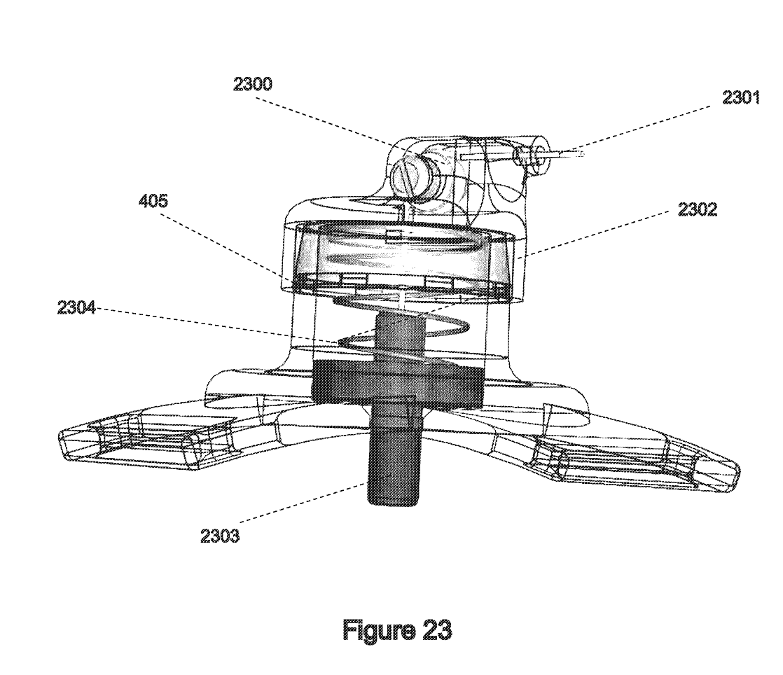

FIG. 23 is a transparent view of an embodiment of the invention. In the figure the invention is fully activated, with the actuator 2303 shown in the strong force position. The control wire 2301 is relaxed to the point where the inner spring 2304 is exerting full pressure on the central guide plate, causing the actuator 2303 to sit at the bottom of the inner chamber. The control wire 2301 slides though a guide hole and over a bearing 2300 which allows the control wire to change orientation by 90 degrees and therefore be aligned with the central axis of the actuator 2303. This embodiment also enables the top cap 2302 to rotate in any direction when worn by the operator. This allows the operator to adjust the orientation of the control wire 2301 according to where the invention is worn on the operator's body. The adjustable rotation of the cap is enabled in the embodiment of FIG. 23 by using a set of clip retainers 2305 that allow the cap 2302 to snap into place and yet rotate around the outside of the base.

Other embodiments employ a screw-on cap, although this can potentially limit the ability to rotate the cap and still maintain a tight fit. One advantage to a screw-on cap is that it can allow the invention to be adjustable in terms of throw length, although this can most simply be controlled by adjusting the control wire mechanism. Other methods of controlling the actuation distance in various embodiments include using a set screw which protrudes into the chamber from the bottom or cap, thereby reducing the travel distance of the actuator. The actuator tip can also be designed such that it has an inner threaded axis and an outer cap, allowing the length of the actuator to be adjusted by twisting the cap clockwise or counter clockwise over the threads on the outside of the inner axis. This threaded inner axis design also allows the actuator tips to be replaced with different tip geometries.

Additional embodiments include an additional component in the base that allows elements in the inner chamber to be inserted through a cap that is fitted to the underside of the base. This can supplement or remove any need to include an upper cap by allowing all of the components to be inserted from the underside of the base.

Further embodiments enable adjustment of the chamber height by allowing the chamber to be replaced with shorter or longer components, and in still other embodiments the chamber is manufacture in different sizes for application to different needs or body geometries.

Embodiments of the present invention further include affixing padded surfaces at various contact points between the operator's body and the invention. Still other embodiments include one or more additional attachments for adjusting placement of the invention.

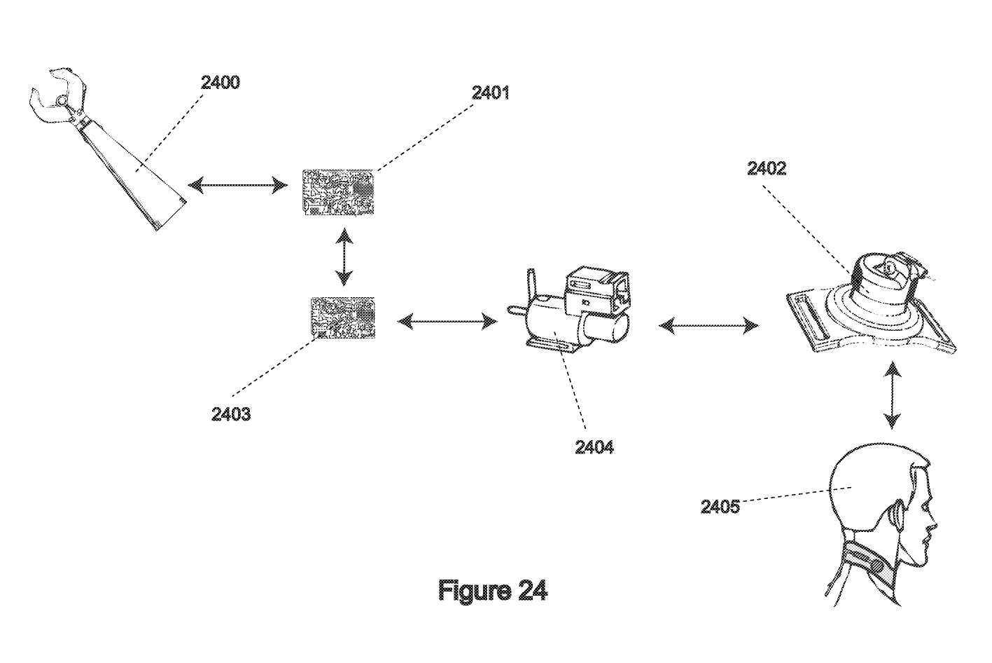

FIG. 24 depicts a typical set of components that are required to control embodiments of the present invention. The haptic device receives some sort of input signal, in this case illustrated as arising from sensors located on a robotic gripper 2400. These signals are acquired and conditioned for use with the invention by a first attached circuit 2401. This first circuit 2401 provides a variety of other functions, including but not limited to power supply, analog to digital conversion, amplification, signal analysis, and interface to additional components in the system. A second circuit 2403, which can be combined with or separate from the first circuit 2401, drives the electro-mechanical components 2404 which control the invention. This second circuit takes the sensor signal and converts it to signals that control the motion of the electro-mechanical components 2404, enabling the control wire to be shortened or lengthened as required by the sensor input 2400. The haptic device 2402 of the present invention is connected to the electro-mechanical components 2404, allowing the haptic device 2402 to be actuated as needed. In some of these embodiments the haptic device 2402 also provides signal feedback to the system through the use of a third circuit or by either the first circuit 2401 or the second circuit 2403. This feedback can be used to adjust the position, power, and/or other environmental elements at the haptic device 2402. The haptic device 2402 is then attached to the body of the operator 2405, so that the haptic input is felt by the operator.

Any or all of the system components illustrated in FIG. 5 can be directly connected, or wireless communications can be provided to aid in portability. In some embodiments the sensor signals 501 are transmitted back to a central control unit. This keeps any extraneous wiring away from the sensor-side mechanisms.

### Examples of Use

Robotics and automation have long suffered from a lack of shared man-machine interfaces. In many cases the operator of robotic components is relegated to operation by the use of hand-eye coordination, and is robbed of the tactile feel which is such a critical part of human dexterity.

There are numerous use cases where the application of haptics, providing an additional sense of feedback to automation users, would increase the capabilities of numerous robotic interfaces. Presently there are two primary means of providing haptic feedback to robotic operators; vibration, and force feedback.

In the case of vibration, the operator interface vibrates in proportion to the level of interaction between the robotic instrument and the target object. This is problematic for delicate operations where an operator does not want any interaction which degrades his or her sensory input. One of the primary reasons to use a robotic tool instead of human hands is to reduce any vibration and/or shaking, not to increase it. Vibration also has limits resulting from the fact that overuse of a vibrating element against the skin causes callousing, which deadens the sense of touch due to thickening on the epidermis. Over time, the vibrating device either has to be moved to another location or its use must be reduced in order to avoid lessening the effectiveness of the vibrational haptic feedback.

Force feedback simulates touch by introducing apparatus that resists the operator in ways that simulate actual motion. This involves using mechanical means to simulate resistance on all places of motion. Resistive feedback, while effective at providing feedback, increases fatigue on behalf of the operator when in use over a long period of time. Force feedback interfaces also tend to be large, unwieldy components that lack portability, have a high cost, and require ongoing maintenance. Lastly force feedback mechanisms suffer from the issue of disengagement. When an operator wishes to use their hands for other actions, the robotic system must determine how to temporarily “park” and then how to reactivate when the operator reengages. This can be problematic depending on how the parking algorithm is designed and the operation being performed.

Linear actuation according to the present invention avoids these deficiencies of the prior art by translating the actions of a robotic instrument into direct and proportional nerve pressure. The level of force applied by any motion undertaken by a robotic system can be translated into a signal that can be used to drive the motion of an actuator. The actuator's motion can then be directly or indirectly applied to the operator on any number of locations on the body, not just the hands.

As described above, linear actuation can be applied as literal pressure in the form of a bladder or plunger which pushed on nerve endings. Actuation can also be used to drive additional systems which translate to other forms of nerve interaction such as squeezing or pinching.

### Example 1

### Surgical

Many surgical procedures are now being performed with the aid of robotic assistants. Surgeries that previously required major procedures can now be performed with robotic instruments that require minimal incisions but provide comparable results.

The surgical robotics, employing techniques commonly referred to as Minimally Invasive Surgery (MIS), also provide benefits in terms of patient positioning and access to hard-to-reach locations. Where they are somewhat deficient is in the ability to provide the operator with the tactile sensation that is so critical to many procedures. The loss of the sense of touch as a result of interfacing with control apparatus has long been one of the main disadvantages of MIS.

Many MIS procedures require dexterity that is hard to approximate without the sense of touch. Simple actions such as maintaining tension on a suture or clamping a vein become nearly impossible tasks. Even the process of displacing becomes problematic, as robotic instruments can create additional damage as a result of undue pressure on surrounding tissue. The sense of touch is vital to nearly all operations performed in surgery, such as inter alia grabbing, clamping, probing, stitching, and cutting.

For a surgeon, the application of pressure on the skin is a natural and easily assimilated feeling. Regardless of the location of pressure, the feeling is identical to the actual sensation of touch. The additional movement of a surgical tool results in proportional pressure applied to a location on the body. The operator requires very little time to connect the two actions, providing a haptic feedback mechanism which is quickly put into use.

Additionally the use of linear actuation addresses critical flaws in the application of vibration and force feedback as haptic devices. Linear actuation does not introduce any factors which cause it to decrease in efficiency over time like the callousing associated with vibration forces. Actuation also does not tire the operator by providing continued resistance, nor does it create issues with how to “park” the interface when the operator must use their hands for other operations.

### Example 2

### Refueling

Robots are often asked to function as an extension of the human operator allow tasks to be accomplished in ways and locations that would normally preclude a human from succeeding. Few tasks exemplify this situation greater than that of aircraft in-flight refueling.

Flying boom systems, which represent one method of air-to-air refueling (AAR), have several advantages including quicker refueling and the capability to be used in more adverse weather conditions then a drogue system. The downside is the requirement for an operator to manually operate the boom's control planes in order to guide it into the receiving aircraft fueling receptacle. The operator is guided only by lights and visual cues. Additional cues such as proximity, alignment, and force are not provided leaving the operator to rely on dexterity and experience. Any sudden changes in conditions or movement of the aircraft outside of the air refueling envelope can lead to disastrous consequences.

The sole use of visual cues as a means of judging distance, pressure, and alignment can be severely hampered by any number of parameters that continually exist at high altitude and high speed. Providing additional sensory input to the boom operator could further reduce the likelihood of potential issues with either aircraft during connection, refueling, and disconnection.

Adding a sense of touch to the boom operator could significantly reduce the most dangerous phase of air-to-air refueling, the connection. The haptic feedback provided by the present invention can be used by an operator to discern alignment, pressure and near-range distance, thereby allowing the operator to guide the boom to the receptacle with greater dexterity even if visibility by both the operator and the receiving aircraft personnel is reduced. Nighttime refueling operations, which afford little visibility, could be performed using pure instrumentation should the sense of touch be provided to the operator by the present invention.

As compared to prior art haptic methods that rely on vibration or force feedback, using direct pressure induction as described herein, for example via the use of a pressurized solenoid or clip, can overcome the limitations of the aforementioned approaches without the loss of sensory perception associated with vibro-tactile solutions or the fatigue and cumbersome nature of force-feedback. In addition, the present invention allows unencumbered manual dexterity, which is crucial since any solution which causes loss or reduction of dexterity can have catastrophic conclusions.

The boom system can be fitted with feelers (and/or any type of pressure or proximity solution) similar to curb feelers in a car. The direct and relative pressure can be translated to a pressure inducer that can be fitted anywhere on the boom operator.

### Example 3

### Public Safety

Robots are frequently used in Public Safety situations, for example when seeking victims trapped by a fire, diffusing an explosive device, or approaching a suspect, either to observe or to disarm. In all of these cases, the robot is acting as an extension of a Public Safety professional, keeping the professional out of harm's way. However, this protective separation between the robot and the operator can also significantly reduce the operator's ability to use his or her senses, which can be critical to the outcome of a situation. Hence, while a Remotely Operated Vehicle (ROV) provides protection, the control interface creates disconnection, leaving the operator to perform manual operations based solely on vision. While it has been proven this limitation can be overcome to some extent by using vision to compensate for a loss of touch, the result still falls far short of full sensory perception.

The haptics of the present invention can provide a means for the operator of an ROV to regain the lost sense of touch, and can aid in numerous situations such as;
Explosive device diffusion
Explosive device extraction
Fire suppression
Forced entry

Without haptics, all of these interactions, at some point during the process, may require a level of dexterity that will require the ROV operator, to use vision (2 or 3D) as a means of compensation for having lost direct tactile feedback.

As compared to prior art haptic methods that rely on vibration or force feedback, using direct pressure induction as described herein can provide a new means of providing haptic feedback by translating the actions of the robotic instrument into direct and proportional nerve pressure. The level of force applied by any motion undertaken by a robotic system can be translated in to a signal that can be used to drive the motion of an actuator. The actuator's motion can then be directly or indirectly applied to the operator an any number of locations on the body, not just the hands.

In the case of an ROV operator, the application of pressure on the skin is a natural and easily assimilated feeling. Regardless of the location of pressure, the feeling is identical to the actual sensation of touch. The movement of the ROV tools results in proportional pressure applied to a location on the body. The operator requires very little time to connect the two actions, providing a haptic feedback mechanism which is quickly put into use. In Public Safety, specifically when dealing with explosive devices, the ability to gently interact with a device using a standard robotic gripper can be the difference between success and failure. Triggered devices may limit the ability of the operator to remove the device from a location, forcing diffusion to happen in-place. This requires care and dexterity normally only achieved with actual human interaction.

Public Safety applications require that ROVs have the capabilities beyond simple “smash and grab” implementations. Dealing with explosive devices, whether in the community or in the field require a level true haptics that cannot be achieved without using the present invention.

### Example 4

### Industrial

Industrial robots manufacture many of the products in use today. They also handle some of the most complex and dangerous operations, thereby removing humans from harm. These operations take place underwater, on land, in space, and in other locations and conditions that would severely impact a human. Recent examples include the Fukushima nuclear power plant and the British Petroleum Gulf oil spill. Other uses less commonly known of include the Canadian Dextrous Manipulator on the International Space Station (ISS) and the Carnegie Mellon Cave Crawler.

All of these applications and environments have at least one aspect in common; the interface between the operator and the robot are disconnected in terms of distance and sensory feedback. There is no better example of this than the robots used at the ISS. Not only are the operators completely removed from sensory input even if connected new factors such as loss of gravity, inertial movement, and lightweight components completely change the nature of the man-machine interface.

To bridge the sensory gap in industrial applications, using the present invention to provide a simulated sense of touch can augment visual feedback and provide the operator with a better level of dexterity and control. This added sensory feedback can translate to better performance and results.

In dealing with the BP Oil Spill in 2011, operators controlling submersible grippers from ships floating above them could have avoided numerous missteps and decreased the damage incurred as a result of poor control interfaces. Several videos of the repair efforts clearly show instances where the grippers crushed components and pipes crucial to the successful capping of the oil flow. The haptic feedback of the present invention would have provided the necessary sensory input that would have allowed the operator to properly use the gripper and avoid causing further damage. The simple act of grabbing a tool or pipe becomes an act of futility when the gripper control only allows for the binary operators of “open” and “close”. Haptic feedback would have also helped in operations where alignment and movement were required such as aligning new pipe fittings or rigging.

At the other end of the spectrum is the operation of robotic systems in space. Due to the change in environmental variables such as weight, gravity, inertia, and resistance the need for increased sensory feedback to the operator is paramount. Whether robotic systems are being used in repairs, cargo management, or retrieval, the sense of touch is magnified by the effect of inertia and the lightweight construction of the components. There are many cases where a robotic gripper could be used by an operator to help with extra-vehicular experiments and repairs but gripping any soft material is extremely dangerous due to gripper strength and lack of feedback.

As is the case with undersea exploration, the lack of true haptic input forces the engineering teams to create a plethora of specialized tools that ultimately increase operational complexity, operational duration due to tool swapping, cost, and weight of the equipment. The inability to provide a full range of sensory input, from the lightest touch to a crushing force, decreases the overall efficiency of the robotic system and increase the risk for potential damage or errors.

In a similar vein, incidents such as the Fukushima nuclear power plan incident support the need for full range, true haptics as these remotely operated vehicles are required to perform a wide range of tasks, some of which require very dexterous operations. The ability to lightly or gradually grip a fitting, pipe, or piece of damaged equipment can be the difference between success and contaminating a site for thousands of years. Tool use and gripping strength are critical. Snapping a bolt while replacing a damaged fixture can create situations where humans must expose themselves to high levels of radiation or the unnecessary shutdown of plant for unexpected repairs. There are several papers written by the US Nuclear Regulatory Commission on the effects of hydraulic line failures leading to rod insertion issues. Thermal stratification can cause these lines to develop “soft” areas that if grabbed tightly by a robotic gripper could rupture causing potential meltdown issues.

These are just a few cases where a vibration-free, non-force-feedback haptic interface would benefit both the operator and the results of robotic use.

### Example 5

### Neuropathy

Applications of the present invention are not limited to robotics. For example, haptic interfaces can be used to either supplement or augment the sense of touch for individuals who suffer from a medical conditions that effect their nervous system, creating nerve damage that can result in the loss of feeling. In particular, diabetic neuropathy, generally believed to be caused by a prolonged level of high blood glucose, affects nearly 70% of all people suffering from Diabetes.

Peripheral Diabetic Neuropathy (PDN) leads to the loss of feeling or tingling in the extremities such as hand, feet, legs, toes, and arms. As a result especially when affecting the legs, toes and feet, there is an associated loss or impairment of balance. This can lead to a significant increase in the number of accidents caused by improper balance, gait, and placement of the feet. The toes and balls of the foot are instrumental in a humans stride and sense of balance. When the feet or toes become numb, there is a significant increase in the number of falls as a result of missteps, improper balance adjustment, or tripping.

To combat this sense of loss, a haptic device of the present invention can be employed which can react to signals received from a set of sensors in the footwear of a diabetic and provide a proportional sense of touch in another region, such as the shin or top of the foot. One approach is to use a sensing device that is similar in form to a shin pad, and a haptic interface including portable power, circuitry, and electro-mechanical components that squeeze or push on the upper leg and shin of the user, allowing the brain to correlate the pressure feedback with the user's gait.

A haptic device of this type can simulate the roll, position, and changes in pressure that occur as a person applies pressure from the ball of the foot through the toes when walking. Or in the case of climbing or descending stairs, pressure on the pad of the foot is felt, allowing the person to shift weight and lift the opposing foot/leg as required.

The device can be fitted in various ways so that it can be affixed to the front of the leg, resting on the shin bone or into footwear so that the haptic feedback is felt on the top of the foot within the footwear. In general, the location of the device can be adjusted to account for peripheral loss of feeling in extremities.

The sensory apparatus can built into form factors such as footwear foam inserts or double layered socks, which are adjustable in size and form while also protecting the sensory components from moisture and direct wear. These form factors also allow the sensor arrays to be disposable and replaced when the sensors wear out. Likewise, the sensors can also be adhered directly to the foot at locations where the loss of feeling is most prevalent.

The combination of sensors in a person's footwear and the wearing of a haptic feedback device can provide the ability for the patient to quickly learn how to adjust the timing of their gait to the feedback of the haptic interface, resulting in fewer accidents and falls.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A haptic feedback device comprising:
a transducer in communication through a drive element with a controller that varies at least one variable feature of the drive element in proportion to at least one sensed parameter;
an actuator cooperative with the transducer, said actuator including a skin-contacting element;
an attachment mechanism that enables attachment of the transducer to an operator, such that the skin-contacting element is located proximal to skin of the operator; and
an actuating mechanism that causes the skin-contacting element of the actuator to be pressed against the skin of the operator with an actuating force that is proportional to the variable feature of the drive element, and thereby proportional to the sensed parameter.

2. The device of claim 1, further comprising a recession device that applies a recession force to the actuator in opposition to the actuating force.

3. The device of claim 1, wherein:
the drive element is a pressurized fluid connecting the controller with the transducer, the fluid being received into a fluid input of the transducer; and
the variable feature is a pressure of the pressurized fluid.

4. The device of claim 3, wherein the pressurized fluid is one of air, nitrogen gas, water, and hydraulic oil.

5. The device of claim 3, wherein the actuating mechanism includes a flexible diaphragm, and the skin-contacting element is an exposed surface of the flexible diaphragm that is extended proportionally outward by the pressurized fluid until the exposed surface presses against the skin of the operator.

6. The device of claim 3, wherein the transducer further includes:
a housing;
a sealed internal volume enclosed within the housing, the sealed volume being filled with the pressurized fluid, the fluid inlet providing fluid communication between the pressure control system and the fluid in the sealed internal volume;
an access port that penetrates a wall of the housing but does not penetrate the sealed internal volume; and
an actuator contained at least partly within the housing, the skin-contacting element being a portion of the actuator that is slidably extendable through the access port to touch the skin of the operator.

7. The device of claim 6, wherein the actuating mechanism includes at least one piston that is mechanically cooperative with the actuator and in fluid communication with the sealed internal volume, so that pressure changes of the pressurized fluid in the sealed internal volume cause proportionate changes of a pressing force applied by the piston to the actuator.

8. The device of claim 7, wherein the piston and the actuator are fixed together as a common element.

9. The device of claim 6, wherein the actuating mechanism includes a flexible diaphragm that separates the sealed internal volume from an unsealed internal volume of the housing, the actuator being contained at least partly in the unsealed internal volume and being mechanically cooperative with the diaphragm, so that pressure changes of the fluid in the sealed internal volume flex the diaphragm and transfer a pressing force to the actuator.

10. The device of claim 3, wherein the pressure transducer further includes:
a chamber having a sealed internal volume filled with the pressurized fluid; and
a mechanical coupling that is reversibly moved in a translational direction according to the pressure variations of the pressurized fluid filling the sealed internal volume, the mechanical coupling being cooperative with the actuating mechanism.

11. The device of claim 10, wherein at least one dimension of the chamber is reversibly expandable and contractible in response to the changes in pressure of the fluid, and the mechanical coupling is a movable wall of the chamber.

12. The device of claim 10, wherein the chamber is a bellows.

13. The device of claim 10, wherein the chamber is a cylinder that drives a piston.

14. The device of claim 1, wherein:
the drive element is a mechanical linkage connecting the controller with the transducer; and
the variable feature is at least one of a linear position and a rotary orientation of the mechanical linkage.

15. The device of claim 1, further comprising a throw adjustment mechanism that adjusts a range of movement of the actuator.

16. The device of claim 15, wherein the throw adjustment mechanism is a ring that is adjusted by rotation thereof.

17. The device of claim 15, wherein the throw adjustment mechanism can be adjusted without opening or disassembling the device.

18. The device of claim 1, wherein the actuating mechanism includes a pair of sides joined by a hinge, the pair of sides being separated in a forward section by a forward gap and in a rear section by a rear gap, the forward gap and the rear gap being either directly or inversely proportional to each other as governed by the hinge, the contact linkage being able to grasp skin of the operator within the forward gap and apply a haptic pressure thereto in proportional to a gap-changing force applied by the mechanical coupling to the rear gap.

19. The device of claim 18, wherein the actuating mechanism is able to grasp a portion of an ear of the operator within the forward gap.

20. The device of claim 19, wherein the attachment mechanism includes a hook that suspends the device from the ear of the operator.

21. The device of claim 18, wherein the drive element is a pressurized fluid supplied to a bellows that expands in length along an expansion axis when a pressure of the pressurized fluid is increased, and contracts along the expansion axis when the pressure of the pressurized fluid is decreased, said bellows being coupled to the rear gap by the mechanical coupling such that pressure variations of the fluid in the bellows cause corresponding forces to be applied to the rear gap.

22. The device of claim 18, wherein the drive element is a pressurized fluid supplied to a cylinder that drives a piston, said piston being coupled to the rear gap by the mechanical coupling so that outward and inward movements of the piston cause corresponding forces to be applied to the rear gap.

23. The device of claim 22, wherein the piston drives a wedge into and out of the rear gap.

24. The device of claim 1, wherein the attachment mechanism includes a band that can encircle and attach to a portion of the operator's body.

25. The device of claim 1, wherein the attachment mechanism provides for attachment to the operator with the skin-contacting element proximal to skin on the neck of the operator.

26. The device of claim 1, wherein the attachment mechanism provides for attachment to the operator with the skin-contacting element proximal to the occipital cranial bone of the operator's skill near the lambda region.

27. The device of claim 1, wherein the at least one sensed parameter includes at least one of a mechanical pressure, a physical position, a temperature, a magnetic field, a level of radioactivity, and an intensity of electromagnetic radiation.

28. The device of claim 1, further comprising a sensing system, the control system being able to vary the variable feature of the drive element according to signals received from the sensing system.

29. The device of claim 28, wherein the sensing system is cooperative with a movable device and generates a signal according to a degree of pressing force between the movable device and another object.

30. The device of claim 28, further comprising a plurality of transducers connected to the controller.

31. The device of claim 30, wherein the sensing system is cooperative with a movable device that can apply a squeezing force to an object, and a pair of transducers are cooperatively controlled by the control system in proportion to a strength of the squeezing force.

32. The device of claim 1, wherein:
the drive element is a flexible actuating wire slidably penetrating the housing and fixed to the actuator, the actuating wire being configured to withdraw the skin-contacting portion of the actuator from the skin of the operator when a pulling force is applied to the actuating wire;
the variable feature is a tension of the actuating wire; and
the transducer further includes a housing.

33. The device of claim 32, further comprising a pulley configured to re-direct the actuating wire, so that the pulling force is applied to the actuating wire along a pulling direction that is not parallel with the longitudinal direction.

34. The device of claim 33, wherein the pulley is configured to allow the pulling force to be applied to the actuating wire along any of a plurality of pulling directions.

35. The device of claim 32, wherein the actuating mechanism is a spring located within the interior of the housing.

36. The device of claim 35, wherein the spring includes tapered coils configured to nest within each other when the spring is compressed, thereby avoiding stacking of the coils when the spring is compressed.

37. The device of claim 35, further comprising:
a cap; and
a threaded interface located between the actuator and the cap, so that loosening or tightening the cap changes the length of the spring, and thereby changes a protrusion and throw of the skin-contacting element.

38. The device of claim 32, wherein the attachment mechanism includes a feature of the housing configured for attachment to a band or to elastic material that can be wrapped around a portion of the operator.

39. The device of claim 32, wherein the device includes a pair of actuators configured to apply a squeezing force to the skin of the operator.

40. The device of claim 32, wherein a length of the actuating wire can be adjusted by operating an adjustable clamping or ratcheting apparatus.

41. The device of claim 32, further comprising at least one sensor cooperative with the actuator, the at least one sensor enabling automatic calibration of the device.

42. The device of claim 1, wherein:
the transducer further includes a housing having an access port;
the drive element is a substantially rigid actuating rod slidably penetrating the housing and having a distal end fixed to the actuator, the actuating rod being configured to vary the extension of the skin-contacting portion of the actuator through the access port when a longitudinal force is applied to the actuating rod; and
the variable feature is the longitudinal force applied to the actuating rod.

43. The device of claim 42, further comprising a lever having a first side fixed to a proximal end of the actuating rod and a second side attached to a control cable, so that a pulling force applied to the control cable is transferred by the lever to the actuating rod.

44. The device of claim 43, further comprising a pressing mechanism configured to apply a force to the actuator tending to oppose the force applied by the control cable and lever.

45. The device of claim 44, wherein the pressing mechanism is a spring.

46. The device of claim 45, wherein the spring includes tapered coils configured to nest within each other when the spring is compressed, thereby avoiding stacking of the coils when the spring is compressed.

47. The device of claim 45, further comprising:
a cap; and
a threaded interface located between the actuator and the cap, so that loosening or tightening the cap changes the length of the spring, and thereby changes a protrusion and throw of the skin-contacting element.

48. The device of claim 42, wherein the attachment mechanism includes a feature of the housing configured for attachment to a band or to elastic material that can be wrapped around a portion of the operator.

49. The haptic feedback device of claim 42, wherein the device includes a pair of actuators configured to apply a squeezing force to the skin of the operator.

50. The haptic feedback device of claim 42, wherein a length of the actuating rod can be adjusted by operating an adjustable clamping or ratcheting apparatus.

51. The haptic feedback device of claim 42, further comprising at least one sensor cooperative with the actuator, the at least one sensor enabling automatic calibration of the device.
